(19) United States
(12) Patent Application Publication
(10) Pub. No.: US 2015/0376946 A1
(43) Pub. Date: Dec. 31, 2015

(54) THERMOPLASTIC PULTRUDED PROCESS AND RELATED PRODUCTS

(71) Applicant: Jershon, Inc., Shelby, MI (US)

(72) Inventors: Rodney Kurzer, Hart, MI (US); Joel C. Soelberg, Dansville, MI (US); Kelly E. Rasmussen, Elk Ridge, UT (US); Ruth Ann Bennett, Provo, UT (US); Jeremy Ellis, Provo, UT (US); Brian Lewis Hiketuro Marler, Provo, UT (US); Michael Todd Peterson, Provo, UT (US); Daniel Roylance, Provo, UT (US); Brandon Zepeda, Monrovia, CA (US)

(21) Appl. No.: 14/748,825

(22) Filed: Jun. 24, 2015

Related U.S. Application Data
(60) Provisional application No. 62/109,204, filed on Jan. 29, 2015.
(60) Provisional application No. 62/018,143, filed on Jun. 27, 2014.

(51) Int. Cl. E06C 7/08; B29C 65/70

(52) U.S. Cl. CPC E06C 7/08; B29C 65/70; B29K 2101/12

(57) ABSTRACT

A pultrusion process comprises steps of: pulling a matrix of continuous reinforcement fibers through a wet-out chamber and forming die while injecting thermoplastic resin (e.g. thermoplastic polyurethane) into the wet-out chamber, and providing secondary stations that remove, reform, and/or add material downstream of the forming die using heat and pressure to form a final beam shape with integrally-formed features thereon. The reinforcement matrix is optimally glass fiber, but can include different types of reinforcements, including strands, bundles, mats, weavings, rods, and other reinforcements and combinations of reinforcements, each of which can be strategically located in the beam profile. The final beam includes intermittent or continuous specialized features integrated into the beam along its length, allowing reduction of material waste, reduced/minimized later assembly, and reduced total number of parts.

### CROSS-REFERENCED TO RELATED APPLICATIONS

This application claims benefit under 35 USC section 119(e) of U.S. Provisional Application Ser. No. 62/018,143, filed Jun. 27, 2014, entitled LADDER HAVING PULTRUDED SIDE RAIL WITH SECONDARILY-FORMED FEATURES and U.S. Provisional Application Ser. No. 62/109,204, filed Jan. 29, 2015, entitled THERMOPLASTIC PULTRUDED PROCESS AND RELATED PRODUCTS, the entire contents of which are incorporated herein by reference.

### BACKGROUND OF THE INVENTION

The present invention relates to thermoplastic pultrusion processes and related products made thereby, and more particularly relates to a pultrusion process where thermoplastic material wets continuous fibers being pulled through a wet-out die to form a continuous beam and inline secondary processes reform and/or add to the continuous beam for functional purposes. For example, side rails for heavy duty extendable ladders can be made this way, where the side rails are high strength, durable, and yet light weight, and also where the side rails have features formed integrally via secondary processes. By this arrangement, the pultrusion process and resulting pultruded product provides a more robust part with fewer total separate parts in the final assembly, lower total weight, and reduced secondary processing and assembly. It is contemplated that the present invention is not limited to only ladders, nor side rails, but instead can be applicable to any pultruded beam where strength and function are needed.

A recent trend is that workers of utility companies include more workers (such as men) who are overweight and also more workers (such as women) who have less upper body strength. As a result, ladders should optimally be designed as durable and robust for use by over-weight workers, but also sufficiently light weight for use by workers not having strong upper bodies. This creates a dilemma, since ladders strong enough to meet strength and stress requirements for heavier workers are often too heavy for lower-strength workers. The problem is exacerbated where heavy-duty ladders are required, such as in utility industries, and in fire and rescue work, and other environments where long or extendable ladders must be manipulated, because back injuries and other work-related issues may occur. Also, ladders must maintain sufficient strengths and stiffness pass stringent testing, such as a horizontal bending test and buckling tests prescribed by ANSI test standards. Also, ladders should be designed to withstand considerable impact against hard objects without chipping, such as when they fall over, or are thrown onto trucks, or come in contact with other hard surfaces.

Some ladders in prior art are made using glass-filled thermoset polyester. However, such ladders are not as light as desired, nor as durable. For example, glass-filled thermoset polyester is subject to chipping and fracturing, especially with abuse while in service, such as when the ladder strikes a hard object in the field or when being thrown onto a utility truck. Also, side rails made of glass-filled thermoset polyester cannot be reformed after curing the thermoset polyester, since cured polyester takes on a rigid structure. Also, holes and openings and other formations must be drilled or cutout, which leads to rough sharp edges, causing potential crack initiation sites, hazard sharp edges, and poor appearance. Also, any accessory, feature or characteristic must be attached via fastening, adhesive, or other securement means. This leads to a whole new set of potential quality problems in terms of inconsistent bonding, many additional “secondary” parts to inventory and attach, and a variety of related assembly concerns. It is noted that known ladder side rails made of glass-filled polyester thermoset resin have a C-shaped cross section formed by 3 perpendicular planar/linear sections. None are molded to include an additional ridge or rib or non-longitudinal lateral (or longitudinal) irregularity beyond the 3 planar/linear sections. This is believed to be due in part because of the manufacturing process used to make them.

An improvement is desired that provides ladders with side rails of relatively high strength, lower weight, and yet that maintains good durability and robustness, especially against hard impacts often encountered during use. Further, improvements are desired in terms of cost, assembly, and safety.

During our investigation, we were unable to find a commercial pultrusion process where thermoplastic resin material was injected into a wet-out die for forming a beam, nor where secondary processing was done in-line and downstream of a wet-out die, such as to reform material and form site-specific features along a length of the beam. Said in a different way, we have been unable to find a commercial process forming a beam, where the beam is thermoplastic material with a high density of continuous reinforcing fibers along its length, and where the beam is reformed and/or “added-to” using in-line secondary processing equipment downstream of the pultrusion wet-out die. We note that known pultrusion processes inject thermoset resins into their wet-out die, with the thermoset resin rapidly cross linking and setting up to form a rigid final part soon after the wet-out die. Since thermoset resins quickly cross link and set up, they do basically not allow reforming of a beam shape downstream of the wet-out die. Thermoset resins are used in pultrusion processes for several reasons, including the fact they have a low viscosity and also they set up quickly to a final shape. Specifically, when first mixed, thermoset resins are quite fluid (i.e. have a low viscosity) and hence (based on historical thinking) were believed to be best able to wet out continuous fibers being pulled through the wet-out die of a pultrusion process. Also, thermoset resins set up quickly, allowing the beam to self-maintain its shape sooner, making the pultrusion process faster, shorter, and lower cost (again, based on historical thinking). This contrasts with thermoplastic resin materials, which tend to be much more viscous when first melted, and also softer for a longer period of time (i.e requiring a longer cooling period) in order to be able to maintain a self-supported shape. Thus, historical thinking in the pultrusion industry has caused them to focus on thermoset materials . . . and to focus away from thermoplastic resin material. Concurrently, thermoset materials have caused the pultrusion industry to focus away from using in-line secondary processing and away from moving (“shifting”) material downstream of a pultrusion wet-out die.

### SUMMARY OF THE INVENTION

In one aspect of the present invention, a method comprises pultruding a first beam shape by pulling long reinforcement fibers through a pultrusion wet-out die; and using secondary stations downstream and in-line with the wet-out die before cutoff to form a final beam shape different than the first beam shape, the secondary stations including at least one of: a material-adding station, a veiling station, a punch station, a material removing station, a drill station, and/or a roll form station.

In another aspect of the present invention, a beam product comprises a pultruded beam having a length and including a plurality of longitudinally-extending continuous fibers extending the length and that are fully wetted by thermoplastic material, the beam defining a constant continuous cross section along the length, but including discontinuous features spaced along the length that interrupt the constant continuous cross section.

In a narrower aspect, the beam product's features include 3-dimensional features extending outside the defined constant continuous cross section that are formed by moving some of the thermoplastic material from a first location on the beam to the 3-dimensional features using heat and pressure.

In a narrower aspect, the beam product's features include openings extending through the cross section, with at least some of the continuous fibers extending unbroken around the openings.

In another aspect of the present invention, a beam product comprises a pultruded beam including longitudinally-extending continuous fibers fully wetted by thermoplastic material to form a continuous cross section, the beam having first and second longitudinally-extending parallel leg sections and a transverse leg section connecting the parallel leg sections, and having a flat elongated strip of high strength material bonded to an exterior surface of each of the parallel leg sections, the strips providing a stressed skin strength to the beam so as to significantly increase a load strength of the beam.

In yet another aspect of the present invention, a process comprises steps of: providing a pultrusion apparatus including in-feed rollers for feeding long continuous reinforcement fibers, a pre-heat surface treatment chamber, a wet-out chamber, an injection nozzle for injecting thermoplastic resin into the fibers in the wet-out chamber, a forming die, a cooling station (such as including cooling air or including a liquid-filled quench basin), and a puller for pulling the fibers through the wet-out chamber and the forming die; forming a continuous pultruded product by injecting thermoplastic resin into the wet-out chamber while pulling the long continuous reinforcement fibers and thermoplastic resin through the wet-out chamber and through the forming die; and cutting the continuous pultruded product to a predetermined length to form a beam.

An object of the present invention is to utilize a pultrusion process to wet out continuous (pultruded) fibers using thermoplastic resin material, thus allowing in-line and downstream secondary processing of the pultruded beam without material waste.

The present invention includes additional aspects particularly focused on ladders. For example, in yet an additional aspect of the present invention, a heavy duty ladder includes a base ladder including pair of side rails connected by transverse rungs, the side rails each including thermoplastic material encasing longitudinally-extending reinforcing fibers to form a constant longitudinal cross section, with at least some of the fibers extending a majority of a length of the side rails.

In a narrower aspect of the present invention, the ladder includes at least one integrally formed feature on each side rail made from a slug of the thermoplastic material of the beam, where the slug is moved by heat and pressure to a new three-dimensional shape having a changed cross section different than the constant longitudinal cross section.

In a narrower aspect of the present invention, the side rails are each made using a pultrusion process, with each of the side rails having a desired high density and distribution of fibers across the longitudinal cross section.

In a narrower aspect of the present invention, the side rails include a three-dimensional feature disrupting the constant longitudinal cross section, the three-dimensional feature being configured to support one of an end of one of the transverse rungs, a leveler, a leveler component, an extension fly ladder, a foot, rung locks, hooks and the like.

In another aspect of the present invention, a base ladder includes pair of side rails connected by transverse rungs, the side rails each being made by a pultrusion process where thermoplastic material wets and encapsulates longitudinally-extending continuous reinforcing fibers extending a majority of a length of the side rails.

In another aspect of the present invention, a side rail for a ladder comprises a side rail including longitudinally-extending continuous fibers wetted by thermoplastic material to form a continuous cross section defining a beam, the beam having integrally formed features defined by the thermoplastic material to support at least one of an extension ladder's side rail, a leveler, a leveler component, a rung connector, and a foot.

In another aspect of the present invention, a side rail for a ladder comprises a pultruded side rail including a plurality of longitudinally-extending continuous fibers fully wetted by thermoplastic material to form a beam defining a constant continuous cross section.

In a narrower aspect of the present invention, the side rail includes 3-dimensional features extending outside the defined constant continuous cross section that are formed by moving some of the thermoplastic material from a first location on the beam to the 3-dimensional features using heat and pressure.

In another aspect of the present invention, a process for manufacturing a ladder comprises forming a pair of beams from thermoplastic material encapsulating longitudinally-extending continuous fibers, with a majority of the fibers extending a length of the beams, each beam having a constant cross section and length and having physical characteristics and properties suitable for meeting ANSI-ASC test standards for side rails of ladders; and attaching rungs between the beams to form a ladder.

In another aspect of the present invention, a side rail for a ladder comprises a side rail including longitudinally-extending continuous fibers fully wetted by thermoplastic material to form a continuous cross section defining a beam, the beam having first and second longitudinally-extending parallel leg sections and a transverse leg section connecting the parallel leg sections, and a flat elongated strip of high strength material bonded to an exterior surface of each of the parallel leg sections, the strips providing a stressed skin strength to the beam so as to significantly increase a load strength of the beam.

In another aspect of the present invention, a ladder comprises first and second side rails each including longitudinally-extending continuous fibers fully wetted by thermoplastic material to form a continuous cross section defining a beam, the beam having first and second longitudinally-extending parallel leg sections and a transverse leg section connecting the parallel leg sections, the transverse leg section having spaced-apart openings formed therein; a plurality of rungs each having a first end positioned in a selected one of the openings in the first side rail and having a second end positioned in an associated one of the openings in the second side rail, the first and second ends each having a protruding portion; and a plurality of brackets secured in the selected one opening and in the associated one opening to secure the first and second ends of the rung to the first and second side rails.

In another aspect of the present invention, a ladder comprises a pair of side rails made of thermoplastic material reinforced with continuous glass fibers extending longitudinally, and a plurality of spaced rungs securing the side rails together, the side rails and rungs combining to provide a ladder bending strength of 13.2 inch deflection in ANSI horizontal bending test, and a total weight of less than 43 pounds.

In another aspect of the present invention, a process includes steps of providing a pultrusion apparatus including in-feed rollers for feeding long continuous reinforcement fibers, a pre-heat surface treatment chamber, a wet-out chamber, an injection nozzle for injecting thermoplastic resin into the fibers in the wet-out chamber, a forming die, a quench basin, and a puller for pulling the fibers through the wet-out chamber and the forming die; forming a continuous pultruded product by injecting thermoplastic resin into a side of the wet-out chamber and while pulling the thermoplastic resin through the wet-out chamber and through the forming die; and cutting the continuous pultruded product to a predetermined length to form a side rail for a ladder.

An object of the present invention is to provide a heavy-duty ladder using pultruded (and/or thermoplastic) side rails that provides a 30% weight savings over an equal-sized heavy-duty ladder with side rails made of glass-reinforced thermoset polyester, or more specifically an innovative 28′ long ladder (when extended) with total weight of less than about 43 pounds (compared to 61 pounds of the ladder with polyester side rails).

An object of the present invention is to provide a heavy-duty ladder using pultruded (and/or thermoplastic) side rails that provides a stiffness of less than 13.2 inch deflection in ANSI horizontal tending test as compared to a standard ladder, which is a 20% increase in stiffness over a standard known ladder.

An object of the present invention is to provide a heavy-duty ladder using pultruded (and/or thermoplastic) side rails that provides an improved bending stiffness over an equal-sized heavy-duty ladder with side rails made of glass-reinforced thermoset polyester.

An object of the present invention is to provide a heavy-duty ladder using side rails made from pultruded (and/or thermoplastic) thermoplastic (such as thermoplastic polyurethane) that provides improved impact properties over an equal-sized heavy-duty ladder with side rails made of glass-reinforced thermoset polyester.

An object of the present invention is to provide a heavy-duty ladder using side rails made by pultruding a long-fiber-reinforced thermoplastic, with features formed integrally into the side rails by secondary processes that reform the thermoplastic in localized areas, causing 3-dimensional variations from the pultruded linear profile.

An object of the present invention is to produce a ladder side rail of plastic material, where the side rail includes a C-shaped profile formed by three joined linear sections and that further includes an additional longitudinal ridge, thus forming a J, T, modified C, X, D, or other similar shape.

An object of the present invention is to produce a ladder side rail including integrally formed features adapting the side rail for attaching one or more of a leveler assembly, a foot, an end cap, or a rung assembly with in-line connectors.

An object of the present invention is to produce a ladder side rail made using thermoplastic material using secondary “squeezing” processes, where temperature and pressure are used to move thermoplastic material from one location to another.

An object of the present invention is to produce a ladder side rail having opposing linear legs connected by a transverse leg, the side rail including long fiber reinforcers, the transverse leg including openings along its middle and at least some of the fiber reinforcers extending around the openings rather than being cut along their lengths.

An object of the present invention is to produce a ladder side rail having opposing linear legs connected by a transverse leg, the opposing linear legs including strips that bond to the linear legs to form a stressed-skin beam.

An object of the present invention is to produce a ladder side rail made of reinforced resin material, where all accessories are attached without using separate adhesive.

An object of the present invention is to produce a ladder with side rails and rungs attached to transverse legs of the side rails, where the rungs extend through openings in the transverse legs of the associated side rails, and end connectors made of resin also extend through the openings to secure the rungs in place.

An object of the present invention is to produce a ladder with side rails and rungs, where the side rails are essentially one piece and include features for securing accessories and rungs to the side rails.

These and other aspects, objects, and features of the present invention will be understood and appreciated by those skilled in the art upon studying the following specification, claims, and appended drawings.

### BRIEF DESCRIPTION OF THE DRAWINGS

FIGS. 1-1A are assembled and exploded perspective views of a heavy-duty extension ladder apparatus embodying the present invention.

FIGS. 1B-1D exploded perspective views showing a base ladder, an extension (fly) ladder and a rung assembly with end connectors, respectively.

FIGS. 2-2A are side and end views of a pultruded side rail such as shown in FIG. 1B, the side rail including pultruded thermoplastic urethane wetting continuous longitudinal glass fibers or fiber bundles (shown as equally spaced, but may include non-equally spacing, linear unbundled glass fibers, parallel glass fiber bundles, parallel and crossing glass fiber bundles, glass fiber woven bands, tapes, rods, or other variations with selected areas of increased or decreased density).

FIG. 2B is a cross section through an assembled base ladder and leveler with extendable leg, illustrating cross sectional shapes and inter-engagement for sliding extension of the extendable leg (see FIGS. 31-35).

FIG. 3 is an exemplary pultrusion process for forming a pultruded side rail for any of FIGS. 1-1C, 2-2A.

FIGS. 4-23 are side views of differently modified side rails with an integrally-formed feature or adaptation made either during the pultrusion process and/or during a secondary process and/or partially in both.

FIGS. 24-25 are perspective views of an integrally-made reformed end configuration of a side rail.

FIGS. 26-26B are perspective, inside and outer views of an end connector for connecting a rung to a side rail.

FIGS. 27-28 are exploded and assembled views of a rung attached using the connector of FIG. 26.

FIG. 28A is a side view of a modified version of the rung connector shown in FIG. 28, for attaching a rung to a side rail.

FIGS. 29-30 are exploded and assembled views of a rung attached using a two-piece end connector arrangement that grips swaged rings on a rung.

FIGS. 31-33 are perspective views showing a ladder with leveler attached to its side rails, the leveler including extendable legs that initially are evenly extended (FIG. 31), but that adjust to uneven ground when lowered (FIG. 32) and then lock in position for standing on the ladder, FIG. 33 showing a close up of the leveler and showing the leveler being attached to an inside of the associated side rails.

FIG. 34 shows a cross section through FIG. 33.

FIG. 35 is a perspective view of a modified leveler similar to FIG. 31, but that is attached to an inside-positioned side rail.

FIG. 36 is a cross sectional view showing a base ladder and fly extension ladder with inter-engaging flanges that permit telescoping extension.

FIGS. 37-38 are perspective views of two different feet that can be attached to a bottom of a side rail (see FIGS. 1 and 25).

FIG. 39 is a modified pultrusion process for injecting thermoplastic resin into a wet-out die, and including in-line downstream secondary processes, including a veil-adding station (i.e. adding an outer skin or skin strips to the pultruded beam for stressed-skin beam strength), and including hole forming station.

### DETAILED DESCRIPTION OF PREFERRED EMBODIMENTS

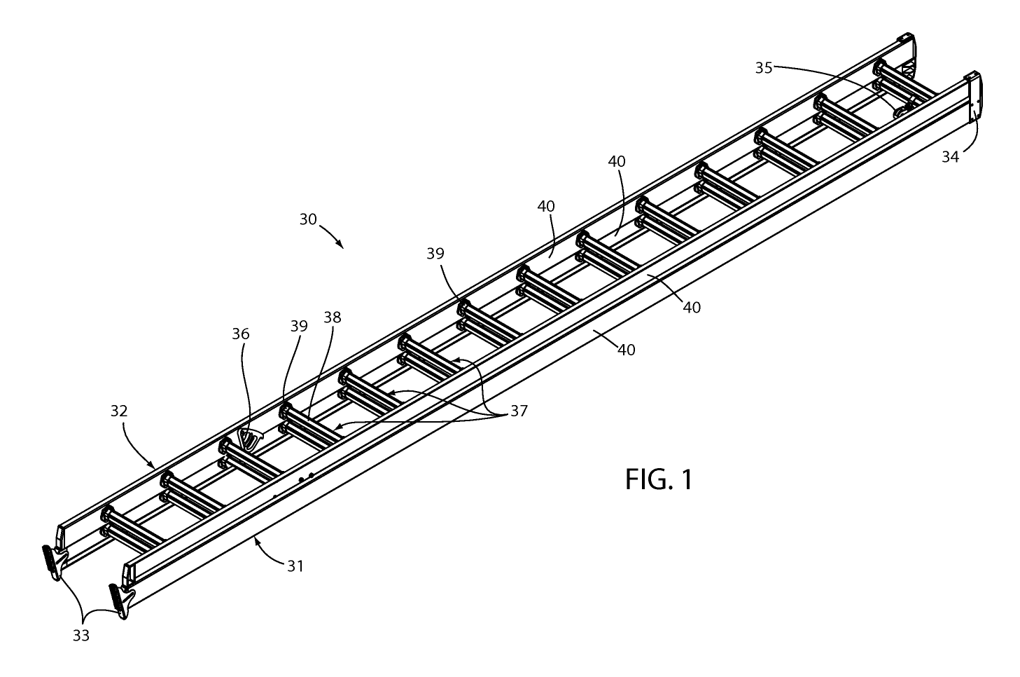

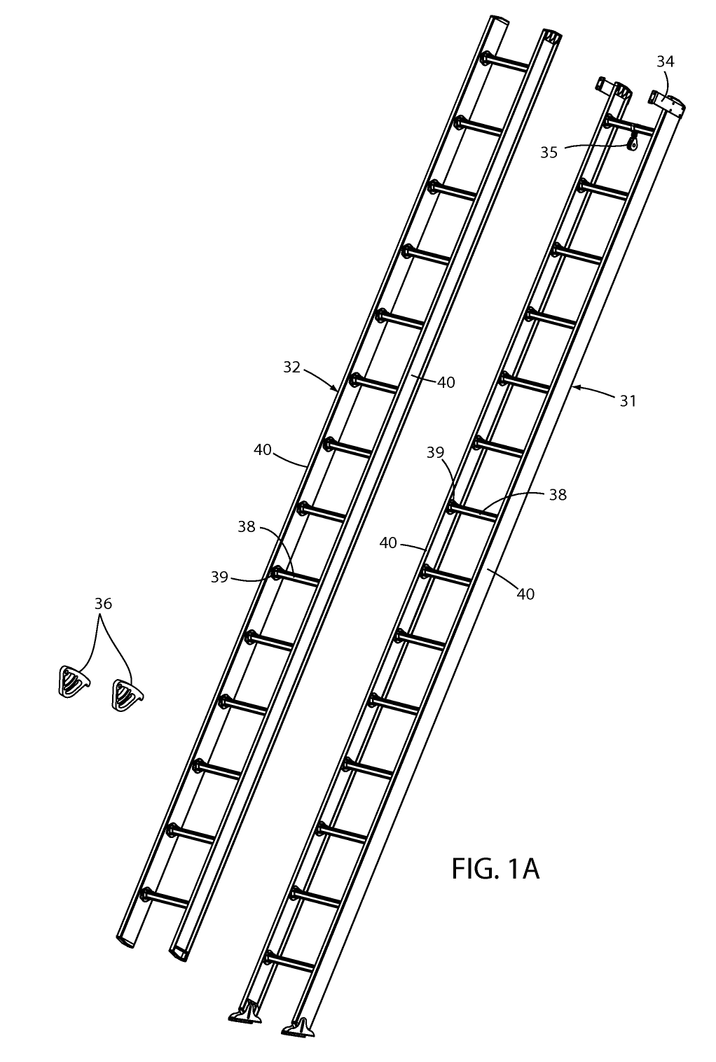

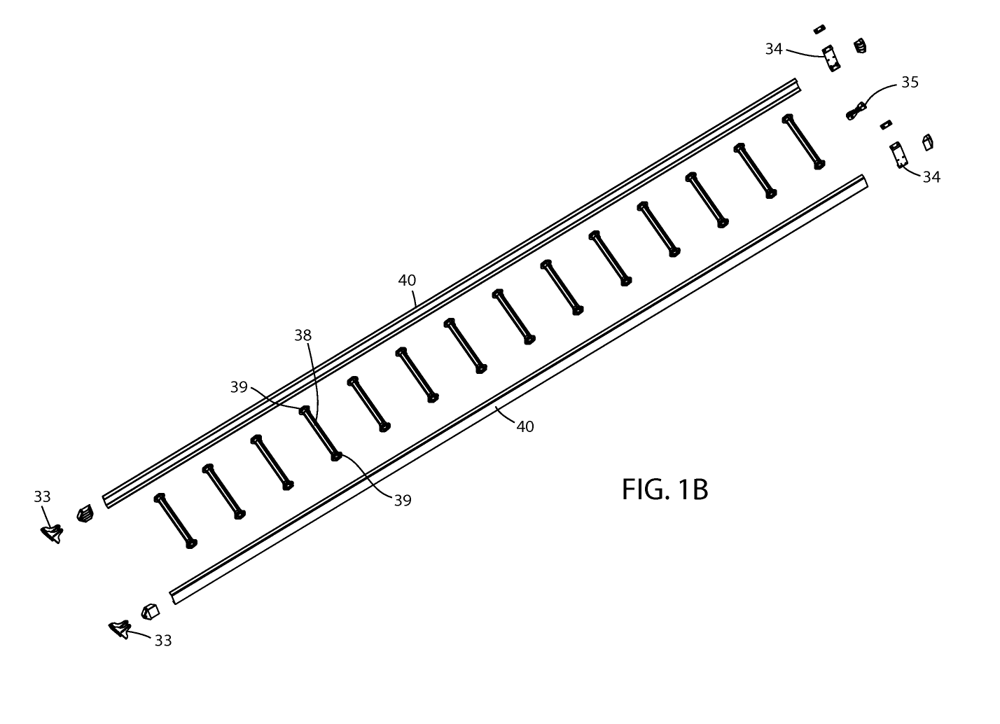

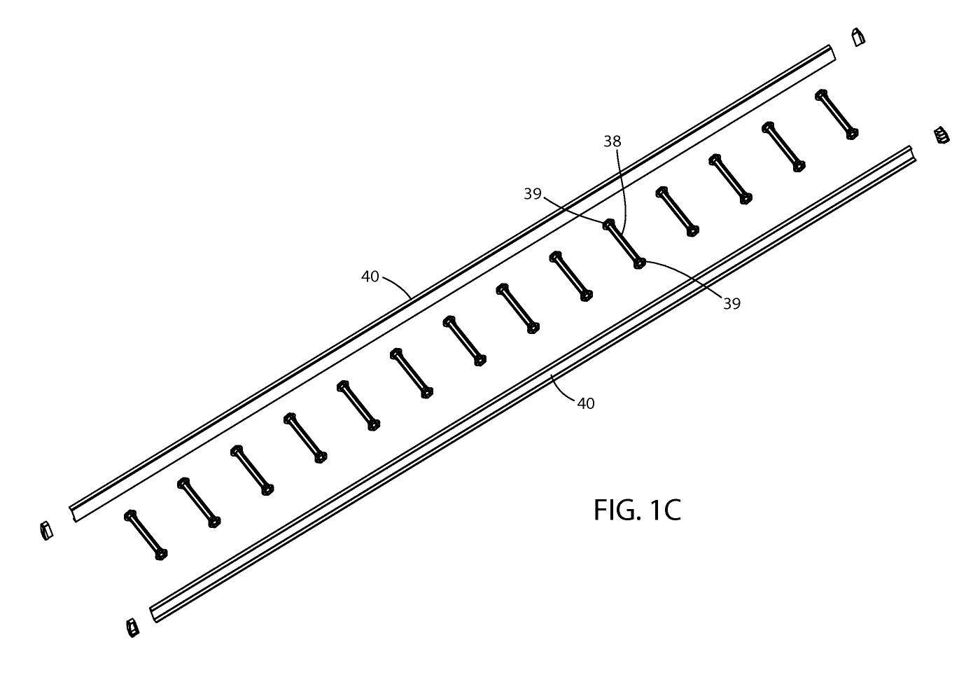

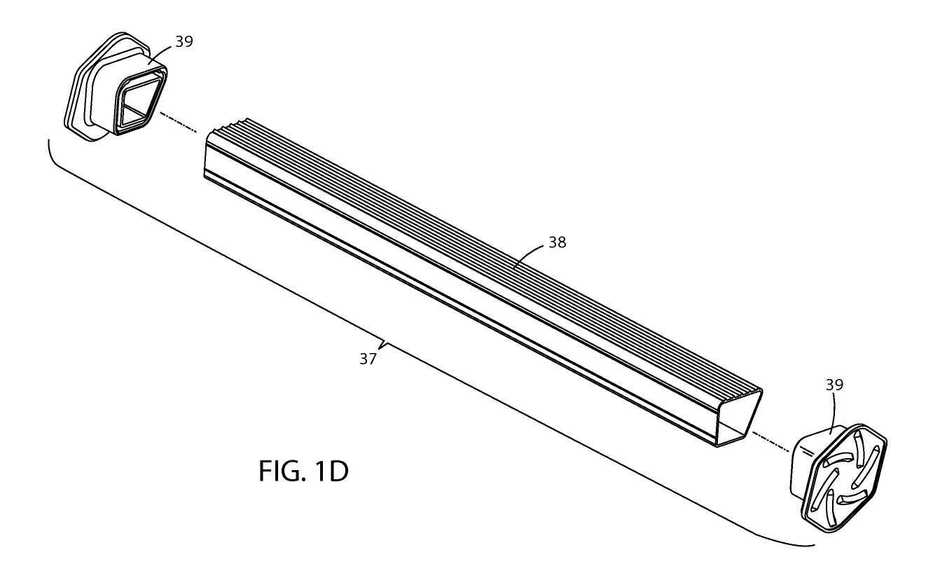

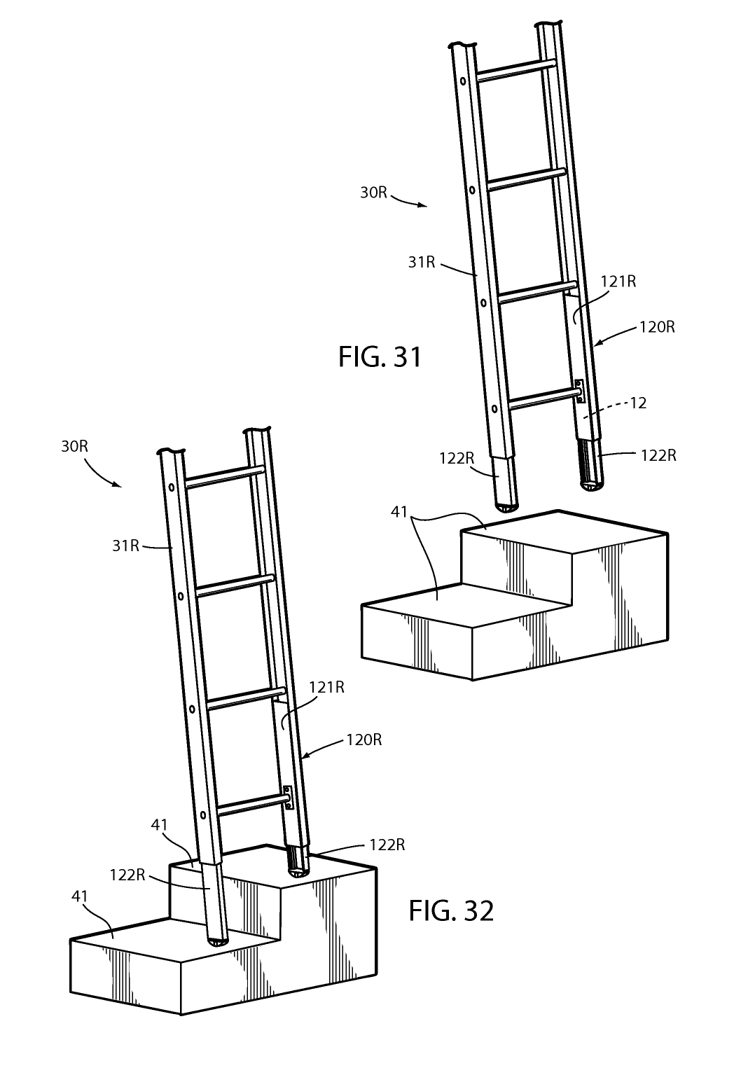

The present apparatus 30 (FIG. 1) is a heavy-duty extension ladder that includes a base ladder 31 (FIG. 1A) and an extension (fly) ladder 32 telescopingly attached thereto. The base ladder 31 includes a pair of feet 33 at its bottom for non-slip engagement with a ground surface, and includes guide brackets 34 at its top for guiding extension of the fly ladder 32, as well as includes a pulley 35 and pull cord (not shown) for pull-cord extension of the fly ladder 32. Rung locks 36 are provided for locking a selected extended position of the fly ladder 32 on the base ladder 31. The ladder 31 (and ladder 32) includes rung assemblies 37 (FIGS. 1B-1D) extending between side rails 40 of the ladder 31 (and 32), the rung assemblies 37 including linear tubular rungs 38 (metal or composite) and rung-securing end connectors 39. It is noted that a leveler may be added to a bottom of the base ladder 31, such as is shown in FIGS. 31-35 and in U.S. application Ser. No. 14/242,311, filed Apr. 1, 2014, entitled LADDER LEVELER APPARATUS. The present description is sufficient for an understanding by persons skilled in this art, but for the reader's edification, the entire contents of the Ser. No. 14/242,311 application is incorporated herein in its entirety for its teachings and disclosure.

The present innovations focus to a significant extent manufacturing a ladder side rail by a novel modified pultrusion process, where thermoplastic resin (e.g. polyurethane) wets out and encapsulates longitudinally-extending full-length-long-fiber reinforcement (e.g. carbon fibers or long glass fibers, or fibers, fiber bundles, fiber strips, fiber mats, tapes, and/or rods). It is contemplated that other thermal forming processes can be used other than pultrusion, such as compression thermoforming processes, or bladder thermoforming processes, or other processes using heat and pressure to form or reform the thermoplastic with reinforcement fibers therein. Secondary processes also can be used to apply heat and pressure to form and/or reform the thermoplastic material to construct integral features (non-linear and linear) into the side rails. Using these innovations, a heavy-duty ladder can be constructed that provides a 20% (or more preferably a 30%) weight savings over an equal-sized heavy-duty ladder with side rails made of glass-reinforced thermoset polyester, or more specifically to construct an innovative 28 ft long ladder (when extended) with total weight of less than about 43 pounds (compared to 61 pounds of a similar ladder with thermoset polyester side rails). Notably, testing has shown that a heavy-duty ladder using pultruded side rails (of thermoplastic reinforced with carbon or long glass fibers) can provide a stiffness of less than 13.2 inch deflection in ANSI horizontal tending test (as compared to a standard ladder), which is a 20% increase in stiffness over a similar standard known ladder. See publically-available and industry known ANSI-ASC test standards for ladders, including ANSI A14.8-2013 and ANSI A14.5-2007 test standards for ladders.

The present innovations also focus on rung attachment and innovations related to same. Notably, the rungs can be tubular metal, or potentially could also be a pultruded material (hollow or filled). It is contemplated that the present innovations are not limited to only ladder side rails, nor to only thermoplastic pultrusions of ladder parts, nor to only rung attachment. Instead, a scope of the present invention is believed to extend to many related concepts as discussed and described herein, as will be understood by persons skilled in this art.

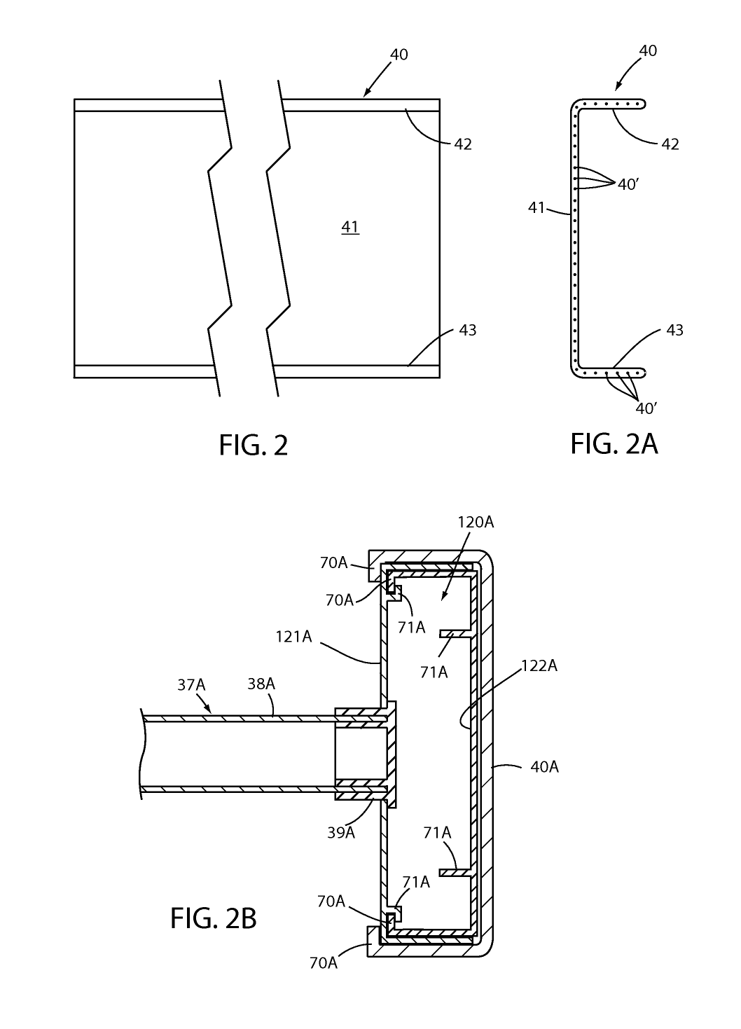

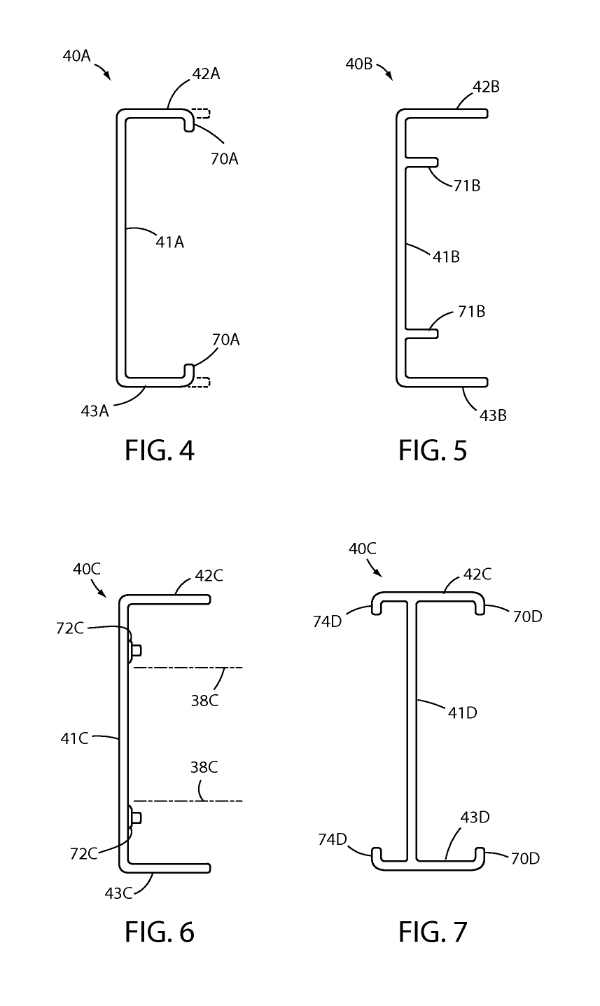

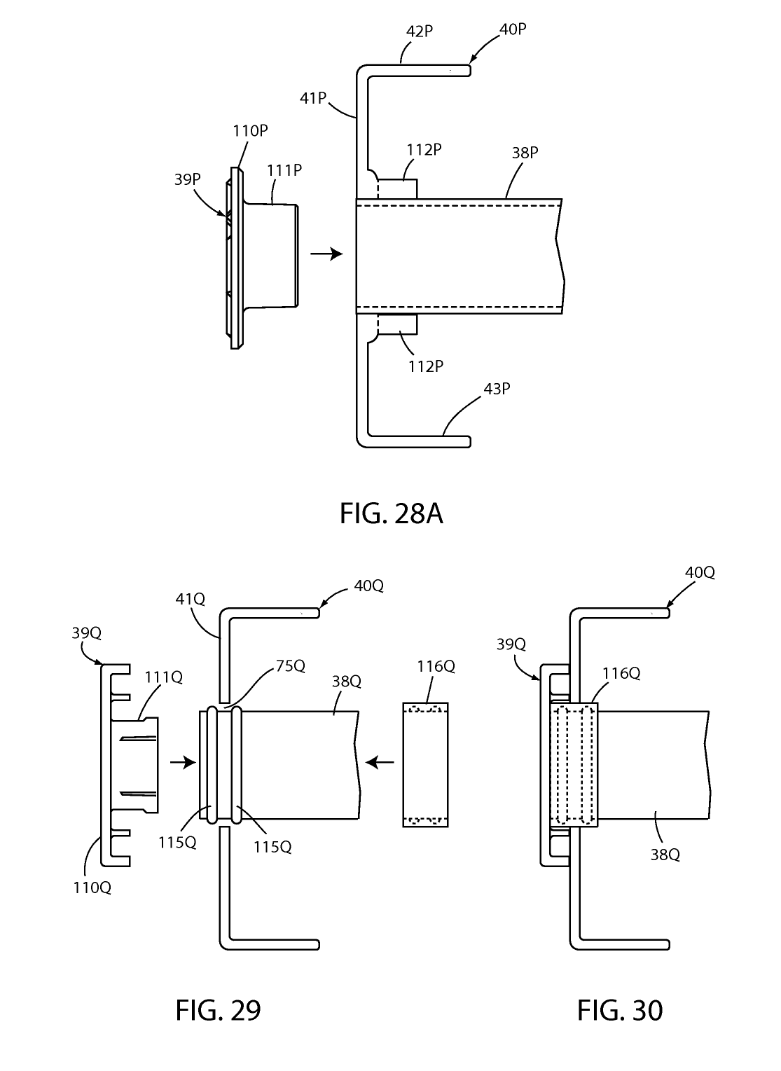

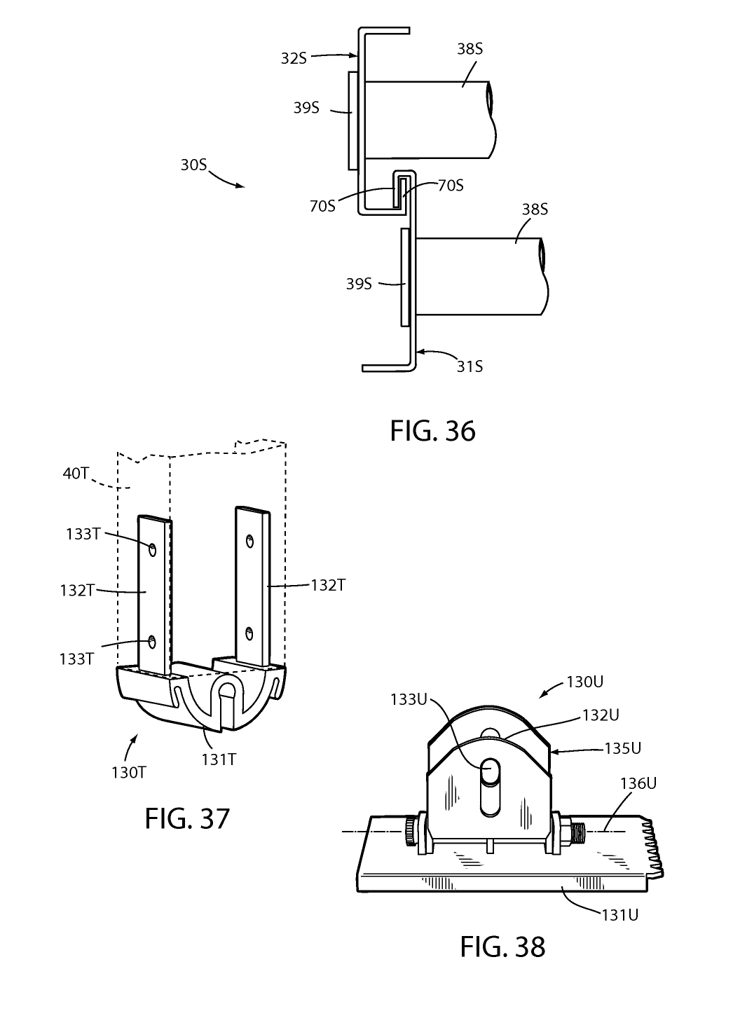

FIGS. 2-2A are side and end views exemplary of the pultruded side rails 40 in FIGS. 1-1C. The illustrated side rail 40 includes thermoplastic polyurethane binding together continuous longitudinal glass fibers 40′. It is contemplated that the long fibers can be a variety of different grades of glass, depending on functional requirements of a particular ladder. The files may come in various forms, such as (linear unbundled glass fibers, or parallel glass fiber bundles, or parallel and crossing glass fiber bundles, or glass fiber woven bands/strips) A scope of the present innovation is believed to include any side rail including a pultruded fiber reinforcement using thermoplastic material regardless of a particular reinforcement type or pattern, and regardless of any particular thermoplastic resin. FIGS. 4-23 illustrate a variety of different side rails included in the present innovation. FIGS. 1D, 26-28 illustrate one rung attachment arrangement, but see FIGS. 28A and 29-30 that illustrate variations. See also FIGS. 31-35 that show a ladder with a ladder leveler attached, FIG. 36 that shows interfacing flanges on side rails for telescopic extension, and FIGS. 37-39 that show two different feet that can be attached to a bottom of a ladder side rail.

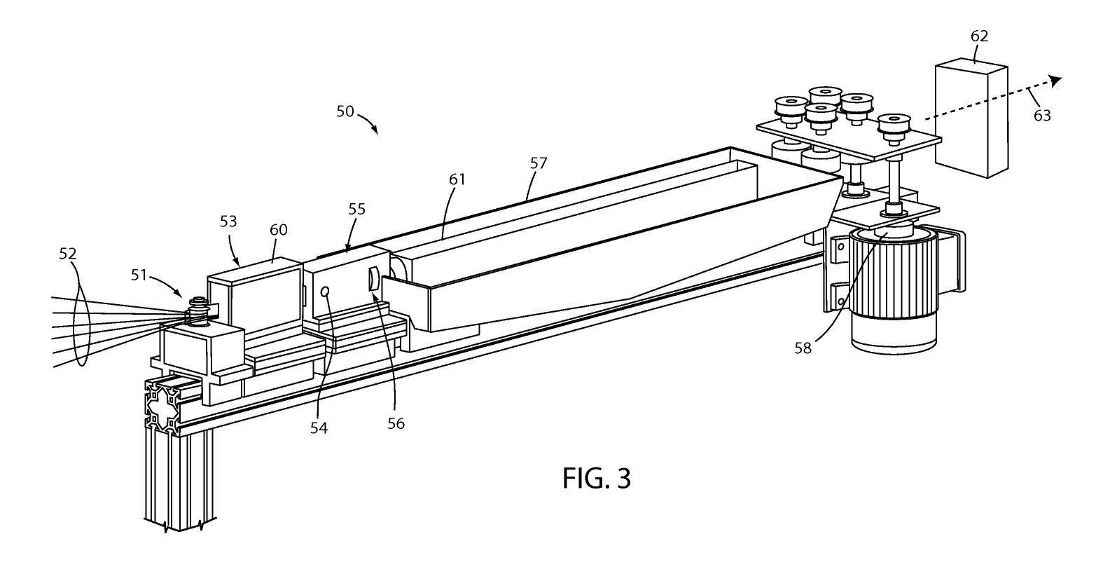

An exemplary thermoplastic pultrusion process (FIG. 3) for forming a pultruded side rail for any of FIGS. 1-1C, 2-2A includes a pultruding apparatus 50. The illustrated pultrusion process includes an in-feed roller(s) 51 for feeding long fibers 52 into the equipment 50, a pre-heat surface treatment chamber 53, an injection nozzle 54 where heated thermoplastic plastic is injected into the wet-out chamber 55, and a vibratory forming die 56. Notably, injection machines are well known and publically available such that it need not be specifically shown for an understanding by persons skilled in this art. The apparatus 50 further includes quench basin 57 and a tractor puller 58 for pulling/drawing fibers from the roller 51 through the wet-out (pultrusion) chamber 55 into the quench basin 57. It is contemplated that secondary reforming tooling can be included at station 60 (near the forming die 56 where the polymer is still hot and formable) or can be included anywhere along station 61 (including near or after the tractor puller 58 where the pultruded beam shape is relatively cooled and where its shape can be refined before final setting and cutting). A cutter 62 is included to cut the pultruded beam shape into lengths suitable for a particular side rail of a ladder. Cut lengths of the pultruded beam shape can be further processed in off-line secondary operations 63 and with secondary tooling, as described below.

More specifically, in the pre-heat surface treatment chamber 53, the roving/tow (i.e. the long glass fibers or continuous reinforcement) are heated to a temperature just above the resin melt temperature being used. This chamber also is used to treat the surface of the roving/tow. The treatment can be varied according to need. Oxides, nitrides, and the like can be added to the surface or corona treatment can be performed. Several gasses or ionized gasses can be introduced into the chamber to treat the surface of the roving/tow. The resin injection chamber 55 is used to improve wet-out. The reinforced resins are used with varying percentages of long fibers, short fibers and/or nano particles (also called “nano-particle reinforcer material” herein) such as carbon or clay nano particles. In particular, our testing suggests that exfoliated nano-clay reinforcer particles of about 2% concentration or less may provide significant increase in beam strength and thermoplastic material stability. Notably, nano-clay particles can be obtained commercially from a company formed initially at Michigan State University in Lansing, Mich. The resin is introduced into the chamber with a flow vector generally perpendicular to that of the roving/tow, though it is contemplated that the resin can be introduced in alternative ways and/or at an angle. This provides cross-sectional or cross-directional reinforcement to the profile and prevents delamination. Vibrating the walls in the resin injection chamber improves wet-out, adhesion to the reinforcement, and to lower processing friction.

The forming die 56 consolidates the continuous reinforcement/fibers by squeezing out excess resin. This further improves wet-out, provides excellent surface finish, and reduces processing friction. Vibration can be introduced by mechanical means (e.g. cams and resonance), voice-coil technology, ultrasound, and other ways. The forming die can be excited (made to vibrate) either perpendicular to or in-line with the roving/tow. Using a wedge die shape causes the vibration to compact or consolidate the roving/tow and cross directional reinforcement. This provides the highest reinforcement density possible. The forming die can be cooled to facilitate release of the resin and improve surface finish.

A significant benefit of using thermoplastic material is the ease of post forming and joining the material in secondary processes. Profiles can be re-heated and formed, welded, or built-up (added to), including flowing and reshaping of the original material to form integrally-formed structures that protrude from the as-pultruded “original” cross sectional shape.

The illustrated pultrusion process pultrudes (pulls through) thermoplastic resin, wetting longitudinally-extending long reinforcing fibers as they move through a forming die. The above-described pultrusion process is particularly adapted for manufacturing the present ladder side rails for many reasons. For example, pultrusion can accommodate uniform and/or non-uniform distribution of fibers across the pultruded cross section, and can accommodate different fibers and differently configured fiber bundles or woven strips, whichever may be optimal to obtain a best set of properties for a particular application of the pultruded product. The present pultrusion process uses vibration on the forming tool, either axially and/or inline, which we believe has never been done. Pultrusion is particularly adapted for the present use since it allows high volume production, and does not require repeated starts and stops of the pultruding process (where the continuous beams are cut in-line with the pultrusion process during manufacture). However, to our knowledge, pultrusion of thermoplastic resin has never been perfected enough to be economically used to produce production parts. To our knowledge, no existing pultrusion process uses pre-heat of the fiber as well as surface treatment of the fiber in the roving/tow preheat and surface treatment changers. We believe these facts alone provide some evidence and support that our pultrusion process is unobvious when used to manufacture a ladder side rail.

The illustrated pultrusion process includes additional features and aspects useful in the present innovation. In the present pultrusion process, molten thermoplastic is injected from a side into the fibers, using vibration to assist in wetting, coating, and encapsulating the fibers. Also, a wedge die is used to compress the molten thermoplastic to assist in wetting, coating, and encapsulating the fibers. Notably, pultrusion allows any profile to be used for providing strategic stiffening, such as allowing thicker profiles, profiles with strategically-located locally-thickened sections, reshaped profiles, and profiles with strips bonded/attached to provide stressed-skin beam strength. A whole new level of secondary processing is allowed, where heat and pressure along with strategic cooling are used to soften and reform the section to form “new” features, as illustrated in FIGS. 4-30.

In the following discussion, similar and identical components, features, and characteristics are described using the same number but with the addition of a letter “A”, “B”, or etc. This is done to reduce redundant discussion, and not for another purpose. It is noted that many of the innovative features described below can be included together in a single side rail, even though they may be shown and described as separate items below.

FIGS. 4-25 are views of differently modified side rails with an integrally-formed feature or adaptation, and secondary processes for forming same. It is contemplated that some of the integrally-formed features can be made in locations “inside” the pultrusion process (when the thermoplastic is still molten or semi-molten), or made when the pultruded shape is semi-solidified or being cooled in the quench basin (when the thermoplastic is sufficiently solid to maintain a given profile), or in secondary processes separate from the pultrusion process/apparatus.

FIG. 4 illustrates a side rail 40A originally pultruded as a C-shaped profile (see FIG. 2A) to include a center leg 41A (also called “transverse leg section”) and opposing top and bottom (outer) legs 42A and 43A (also called “parallel leg sections”, but it is reformed using secondary tooling at any of locations 60, 61, 63 (FIG. 3) to add, for example, secondary edge flanges 70A along the free end of each leg 42A and 43A. See the flange 70A in the side rail 40A of the extension fly ladder 32 in FIG. 2B. If this reforming secondary operation is done adjacent the pultrusion-forming die 56 at location 60, the thermoplastic is still (potentially) fluid enough to permit bending/reforming of the profile's edge without the addition of heat. At end-of-pultrusion-line location 61, and at off-line location 63, heat will most likely need to be added in order to reform the edge to form edge flanges 70A, either by using a warm (hot) tool or by localized preheating prior to reforming.

Since the resin of the illustrated side rails is a thermoplastic, it can be reheated, melted (or softened), reformed using heat and pressure (where the thermoplastic material is either “bent” or is “captured and flowed to a new location”), and then re-cooled to maintain its reformed shape. It is noted that equipment capable of localized heating of the thermoplastic resin is known and need not be described in detail herein for an understanding by persons skilled in this art. The secondary forming equipment can include a hot iron or other hot mandrel or molding die(s) or oven or heat-generating device to heat the material and reshape the profile as desired. Notably, the illustrated edge flanges 70A combine with the legs 41A-43A to form a track, such as is useful for sliding engagement between the side rails of the base ladder and extendable fly ladder. Also, the flanges 70A can be used to capture a leveler or to slidably engage a leveler component (e.g. an extendable leveler leg) as discussed below.

FIG. 2B is a cross section through a side rail 40A of a base ladder 30A including one of the edge flanges 70A illustrated above. FIG. 2B also illustrates a leveler 120A (see FIGS. 31-34, and in particular FIG. 34) with an anchor bracket 121A secured to the side rail 40A, and an extendable leveler leg 122A telescopingly engaging in-board flange 71A on the extendable leg 122A for sliding extension. It is contemplated that the extendable leg 122A will, like the side rail 40A, be a fiber-reinforced pultruded thermoplastic. The leg 82A includes edge flanges 70A′ similar to edge flange 70A, and also includes inboard flanges 71A′. The illustrated side rail 40A may or may not include an edge flange 70A (shown in dashed lines). It is noted that the particular illustrated profile with legs 41A-43A and edge flanges 70A in FIGS. 4 and 2B could be formed entirely by the forming die 56. Nonetheless, the above discussion illustrates the flexibility of the present innovation.

FIG. 5 illustrates a side rail 40B originally pultruded as a C-shaped profile (see FIG. 2A) to include a center leg 41B and opposing top and bottom legs 42B and 43B, but further formed to include inboard flanges 71B. It is contemplated that the flange(s) 71B can be formed in the forming die 56 as part of the basic pultruded profile, or can be reformed in a secondary operation after the forming die 56 using secondary tooling at any of locations 60, 61, 63 (FIG. 3). If done in locations 61 or 63, the secondary tooling includes squeezing dies that basically squeeze thermoplastic material from a thickened portion of the adjacent leg (see FIG. 6) and move the squeezed material to a new location, thus forming the flange 71B (FIG. 5). In other words, the material of flange 71B is flowed using heat and pressure from its pultruded location to a desired shape in a post-pultrusion process. Depending on a size and length of the secondary inboard flange 71B, a thickness of the leg supporting the inboard flange 71B can be made larger and/or thicker to supply the material needed for the flange 71B. It is contemplated that the secondary inboard flange 71B can be added anywhere it is needed along one of the center or legs 41B-43B, including inwardly-extending and outwardly-extending locations. FIG. 5 illustrates the inboard flange 71B as being on the center leg 31B, but it is noted that it could be in the outer legs 42B and 43B.

FIG. 6 illustrates a side rail 40C originally pultruded as a C-shaped profile to include a center leg 41C and opposing top and bottom legs 42C and 43C, but notably the center leg 41C includes enlarged thickened sections 72C. The enlarged thickened section 72C of FIG. 6 can be used for an in-board flange 71C. Instead, they can be used to support a rung 38C or rung connector 39C.

FIG. 7 illustrates a side rail 40D originally pultruded as a C-shaped profile (see FIG. 2A) to include a center leg 41D and opposing top and bottom legs 42D and 43D, but further formed to include outboard flanges 74D. Side rail 40D (FIG. 7) is not unlike side rail 40B (FIG. 5), but the outboard flanges 74D are formed to extend parallel outer legs 42D and 43D to an opposite side of the center leg 41D. Further, the flanges 74D include a hook shape, such that they form a track along a “back” side of the center leg 41D. Notably, it is contemplated that the outboard flanges 74D can be formed in the forming die 56, or in any of locations 60, 61, 63 by squeezing dies to flow and reform the thermoplastic material. It is noted that in some circumstances, the flanges 74D may not extend fully along a length of the side rail. In such case, the secondary tooling at one of locations 60, 61, 63 becomes more attractive, since the reforming secondary process can be done intermittently as the profile pultrudes from the forming die 56.

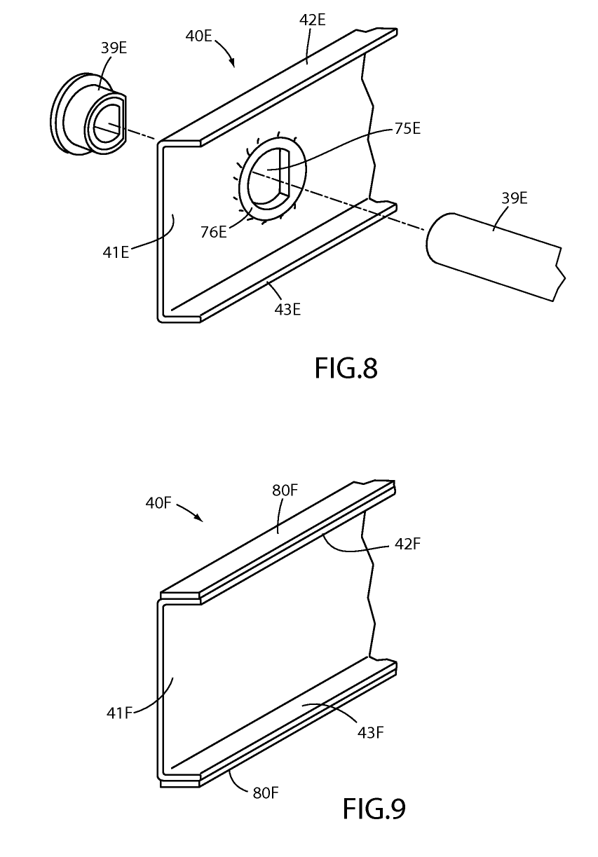

FIG. 8 illustrates a side rail 40E originally pultruded as a C-shaped profile to include a center leg 41E (also called “transverse leg”) and opposing top and bottom legs 42E and 43E, but further formed to include a repeated pattern of openings 75E along a length of the center leg 41E. Notably, a majority of the stress-resistance or bending strength of a side rail comes from the legs 42E and 43E, with the center leg 41E primarily serving to maintain a spacing of the legs 42E and 43E for engineering torsional/bending strength. Since a thickness of the transverse leg 41W is less critical, the openings 75E can be used to lighten a weight of the side rail 40E without significant loss of bending strength of the side rail. Further, some of the openings 75E can be used to receive an end of a rung 38E or rung connector 39E, as discussed below. In the illustrated opening 75E, the thermoplastic material can be removed from the hole (i.e. drilled or punched out), or the thermoplastic material can be moved/reformed to form a thickened ring 76E around the opening 75E. Where material is removed to form the opening 75E, it is noted that longitudinal reinforcement fibers will be cut. Where the material is moved laterally, it is contemplated that the reinforcement fibers can, instead of being cut, be flowed with the thermoplastic material. This causes an accumulation of fibers near the top and bottom edges of the openings 75E as the fibers extend past the openings 75E, resulting in increased support for the rung 38E and rung connector 39E. It is noted that the side rail 40E of FIG. 8 can be made originally to a profile similar to side rail 40C in FIG. 6, which provides additional material along a center of the center leg 41E to facilitate the reforming process.

FIG. 9 illustrates a side rail 40F originally pultruded as a C-shaped profile to include a center leg 41F and opposing top and bottom legs 42F and 43F. However, strips of material 80F are bonded to the outer legs 42F and 43F, doubling a thickness of the legs 42F and 43F. It is contemplated that the strip of material 80F will be a non-conductive material in a same family of materials as the pultruded thermoplastic material, which as illustrated is polyurethane. By having the material 80F and the pultruded thermoplastic material of the side rail 40F be the same material or of a same family of material, they can be integrally bonded without using a separate adhesive or separate bonding material. It is contemplated that the bonding can be accomplished by simply reaching a sufficient temperature to cause inter-layer bonding (also called “interface bonding” herein). For example, if the strip 80F is introduced into the forming die 56, the material may be sufficiently hot and fluid to wet and bond directly to the strip 80F. Where the bonding is done downstream of the forming die 56, the bonding can be done by re-heating, or done by other means, such as rf bonding/welding, sonic or ultrasonic or vibratory-based friction bonding/welding, or solvent welding.

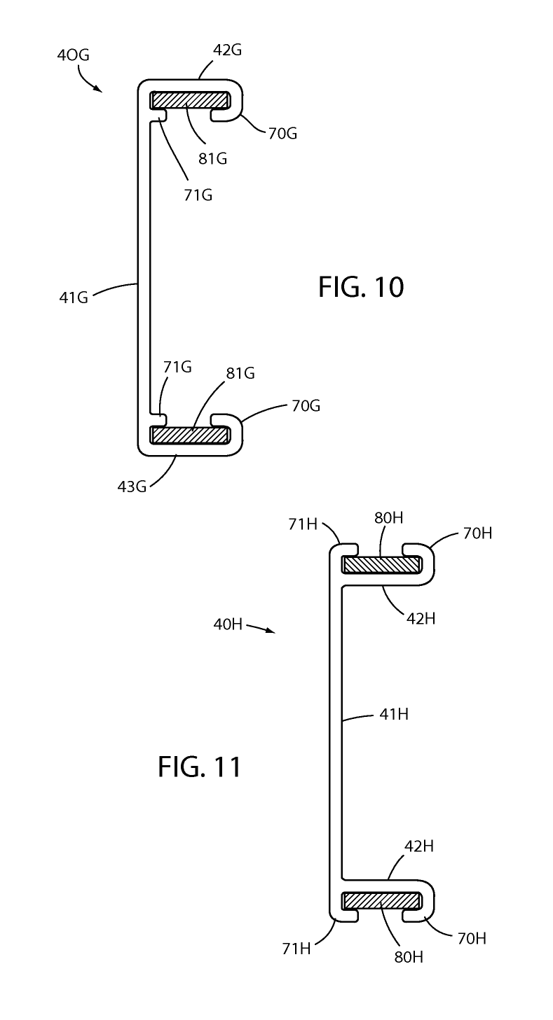

FIG. 10 illustrates a side rail 40G originally pultruded as a C-shaped profile to include a center leg 41G and opposing top and bottom legs 42G and 43G. In side rail 40G, inboard flanges 71G capture strips 81G on an inboard side of the outer legs 42G and 43G. Strips 81G can be similar to or identical to strips 80G described above. Where the strips 81G extend a full length of the side rail 40G, the strips significantly strength and stiffen the side rail 40G. However, it is noted that in some cases, the strips 81G may extend only several inches and may include a functional feature, such as undulations or spaced openings creating a rack. For example, the strips 81G could form a rack as is used by the leveler described in FIG. 30 below.

FIG. 11 illustrates a side rail 40H originally pultruded as a C-shaped profile to include a center leg 41H and opposing top and bottom legs 42H and 43H, and further includes strips 80H similar to FIG. 9, but in FIG. 11 the strips 80H are on an outboard side of the outer legs 42H and 43H. Also, the outer legs 42H and 43H include L-shaped flanges 71H that assist in capturing the strips 80H.

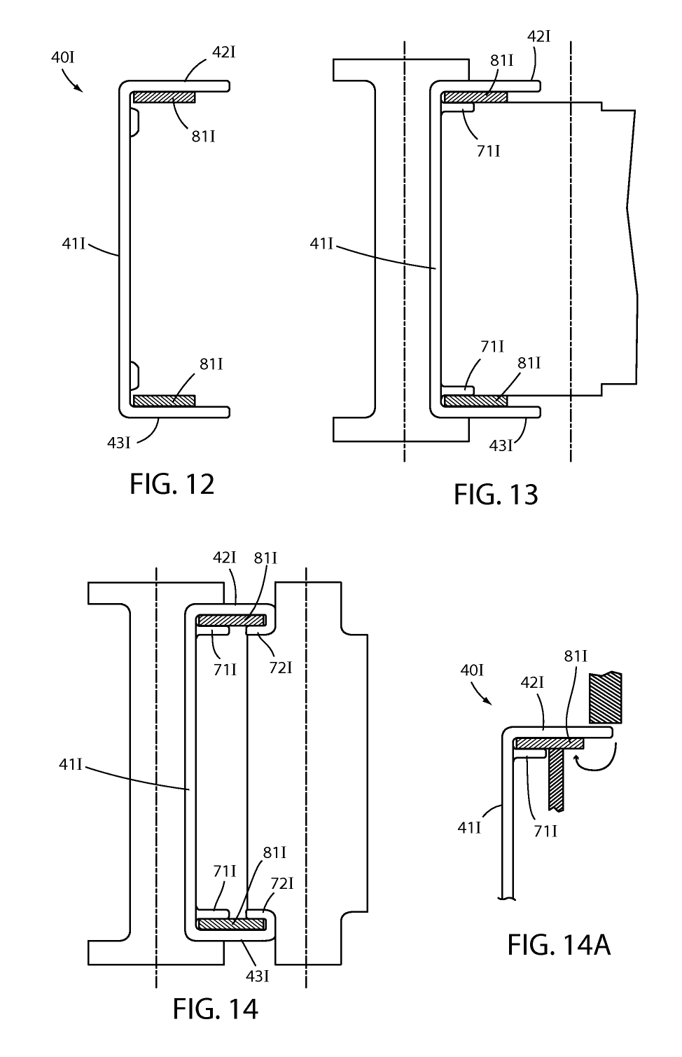

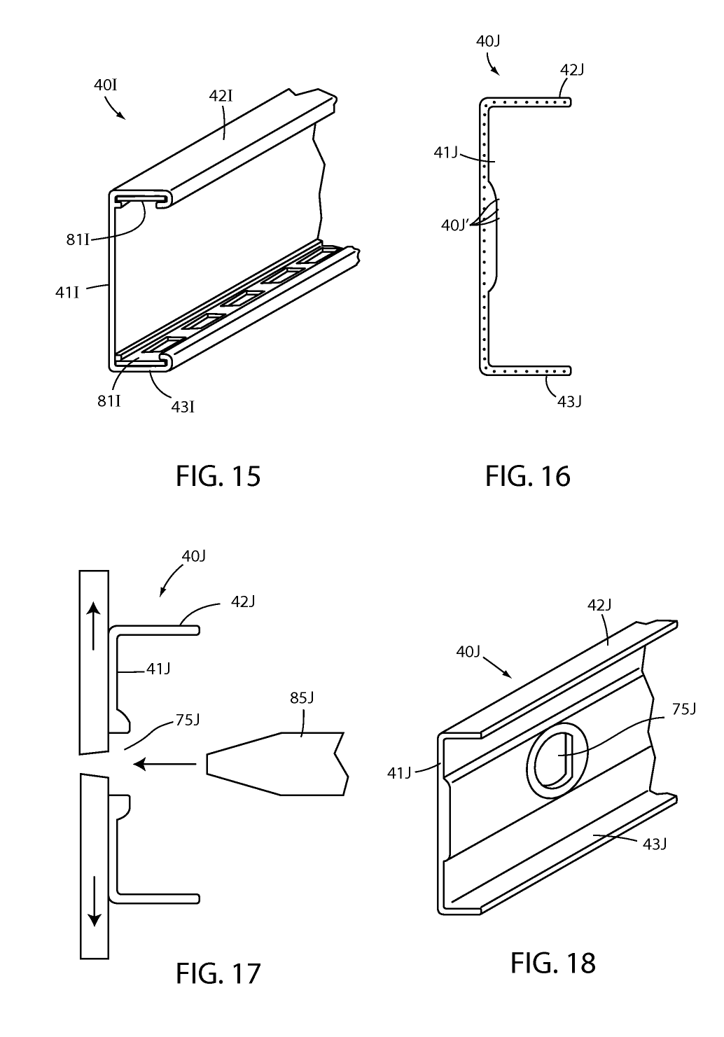

FIGS. 12-15 show a secondary process for retaining a rack in a pultruded side rail 40I. The side rail 40I (FIG. 12) is initially pultruded as a C-shaped with legs 41I-43I, and with two flanges 71I extending inboard from the center leg 41I. In a secondary processes (FIGS. 13-14), a strip 81I is placed against the inside surface of the outer leg 42I (and 43I), an inboard flange 71I is formed to abut and capture an inside edge of the strip 81I (FIG. 13), and subsequently the edge flange 70I (FIGS. 14-14A) is formed around the outer edge of the strips 81I to fully capture the strips 81I in place. As shown in FIG. 15, the edge strip 70I can be formed by mechanically bending the edge flange 70I around the end of the strip 81I. It is noted that the strip 81I can provide different functions. In addition for stiffening the side rail, it also can include a series of spaced holes (FIG. 15) or undulations forming a rack that can be engaged with a pinion gear of a leveler (see FIGS. 15 and 34).

FIGS. 16-18 show a secondary process for forming rung-engaging openings 75J in side rail 40J. The side rail 40J (FIG. 16) is initially formed with a center leg 41J and side legs 42J and 43J, with the center leg 41J being thickened along its center region. A pointed/tapered die 85J (FIGS. 17-18) is used to periodically penetrate a center of the thickened center region, thus separating the thermoplastic material to form the spaced-apart rung openings 75J. The die 85J is pointed so that upon penetration it concurrently and gently spreads the long reinforcement fibers 40J′ apart around the opening 75E without unacceptably fracturing or cutting the fibers 40J′ in the center leg 41J. The result is a raised ring or ridge of thermoplastic material formed around the rung opening, which reinforces the strength of the opening. It is noted that some care may be required to not unacceptably pull adjacent fibers 40J′ longitudinally during this fiber-lateral-spreading process. Alternatively, in some cases, the center-most fibers 40J may be intentionally cut (such as by drilling or stamping or punching), thus leaving only fibers 40J near the outer edges intact and uncut. Notably, the outer fibers 40J don't have to be moved as far as the center-most fibers, and thus have less tendency to pull longitudinally (be stressed longitudinally) when laterally displaced/moved to make the openings 75J. In some cases, the fibers may intentionally be spaced away from a center of the transverse leg in the forming die 56 (or a middle of the transverse leg purposefully be made void of fibers), or a different arrangement of fibers (i.e. fibers capable of lateral movement without concurrent longitudinal pull) may be used. This can be achieved by testing and knowledge of particular requirements of a particular ladder assembly.

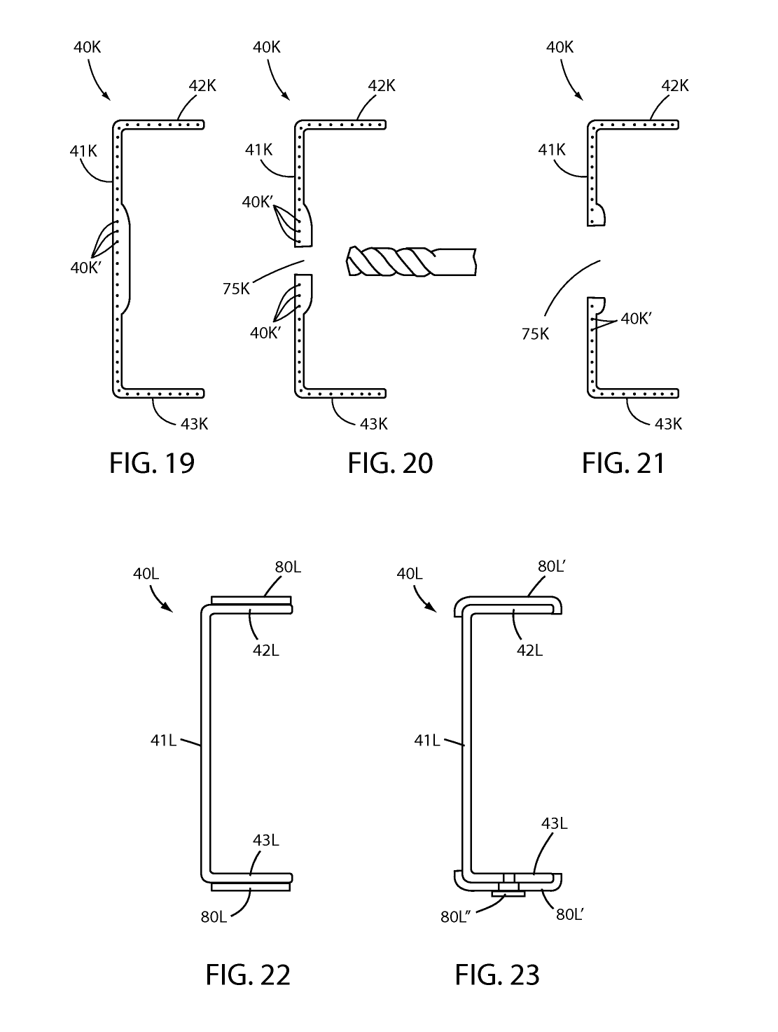

FIGS. 19-21 show another secondary process for forming rung-engaging openings 75K in side rail 40K similar to FIGS. 16-18, but where it is not important to maintain uncut fibers within the center leg 41K. Notably, the center leg 41K does not contribute much too bending strength other than stability of the outer legs 42K and 43K. Thus, in some side rails, it is not important for the fibers 40K′ to remain uncut inside the center leg 41K. In the side rail 40K, the pultrusion initially forms center leg 41K and side legs 42K and 43K, with an enlarged section 72K. A hole (opening 75K) is drilled or stamped/punched into the center leg 41K, cutting some of the fibers 40K′ thereunder. If desired, part of the process can be to reform a thickness of the thermoplastic material around the opening 75K as part of the opening-forming process, such as by extruding material from a punched/drilled shape to form a ridge of thermoplastic around the opening 75K.

FIGS. 22-23 show a side rail 40L similar to side rails 40F and 40H. In side rail 40L, a center leg 41L and outer legs 42L and 43L are formed, and strips 80L are bonded to the outer surface of legs 42L and 43L through use of sonic or vibratory or friction welding. Then, in FIG. 23, the strip 80L′ is extended onto 3 sides of the legs 42L and 43L. It is contemplated that alternatively, the thermoplastic material from the legs 41L-43L can be reformed and squeeze-formed to laterally flow thermoplastic material around the edges of the strips 80L, thus capturing them. It is noted that thermoplastic material can also be flowed into and through holes in the strips 80L (see integral rivet 80L) to secure the strips 80L to the legs 41L-43L in a manner similar to integrally-formed rivets. Restated, the rivet-like material can end up being similar in shape to a hot-staked boss where its head is thermally shaped to form a rivet-like head preventing separation. Notably, the side rail 40L forms a stress-skin beam arrangement having exceptional bending and horizontal stiffness qualities.

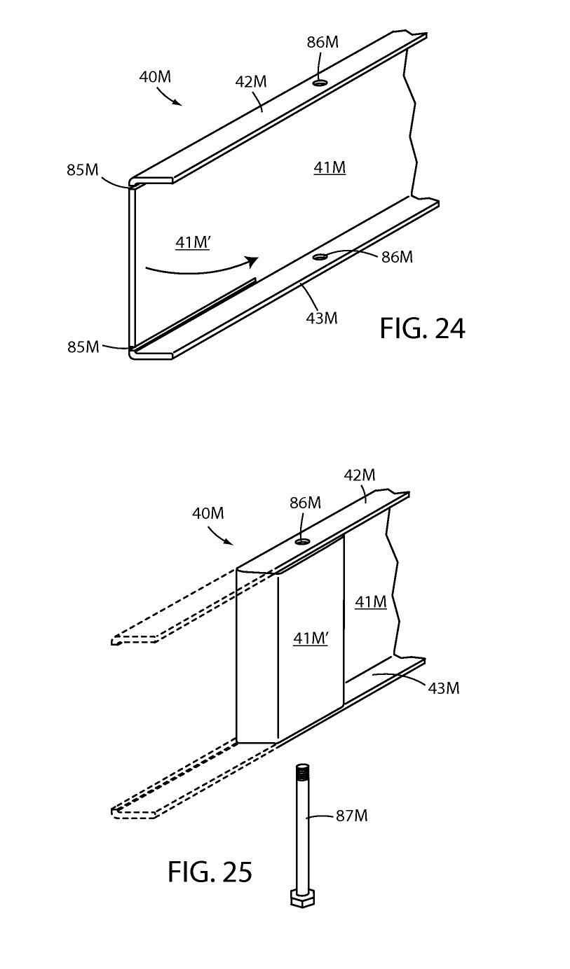

FIGS. 24-25 show a side rail 40M where slits 85M are formed at corners between the transverse leg 41M and opposing legs 42M and 43M, the slits 85M being formed longitudinally from an end of the side rail 40M. The section 41M′ of the transverse leg 41M between the slits 85M can be reformed and doubled-back so that it lies between and touches the free edges of the opposing legs 42M-43M. The doubled-back section 41M′ of the transverse leg 41M can be welded/bonded to the opposing legs 42M, 43M to form a box section having very strong properties, suitable for supporting a foot (see FIGS. 1, 37-38). Holes 86M are formed to receive threaded fixtures/bolts 87M to attach feet. (See FIGS. 37-38). The protruding strips (see dashed lines) can be cut away.

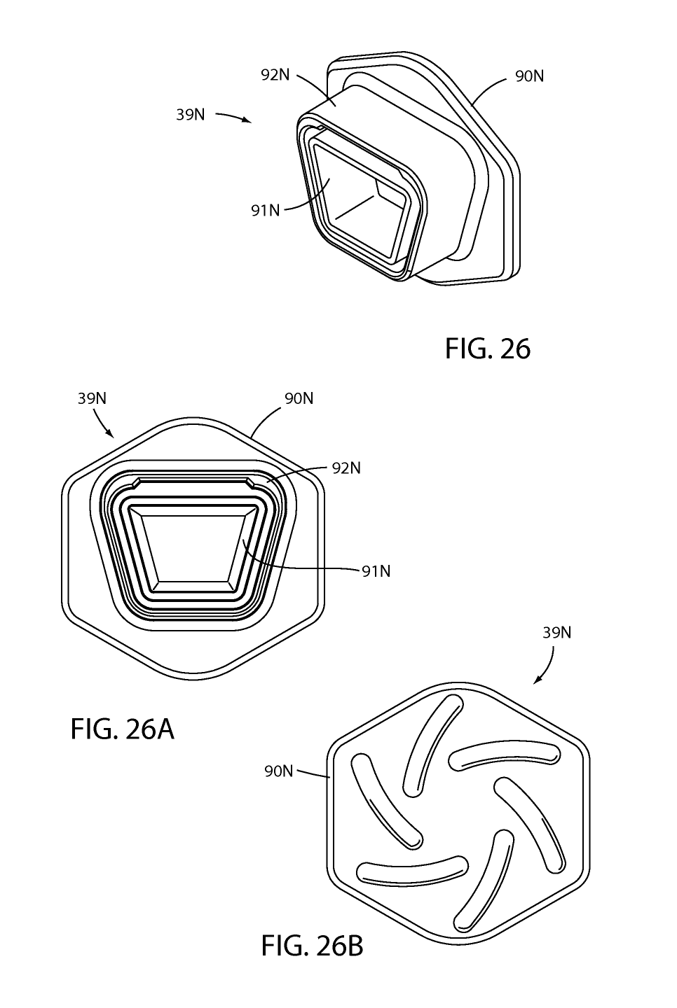

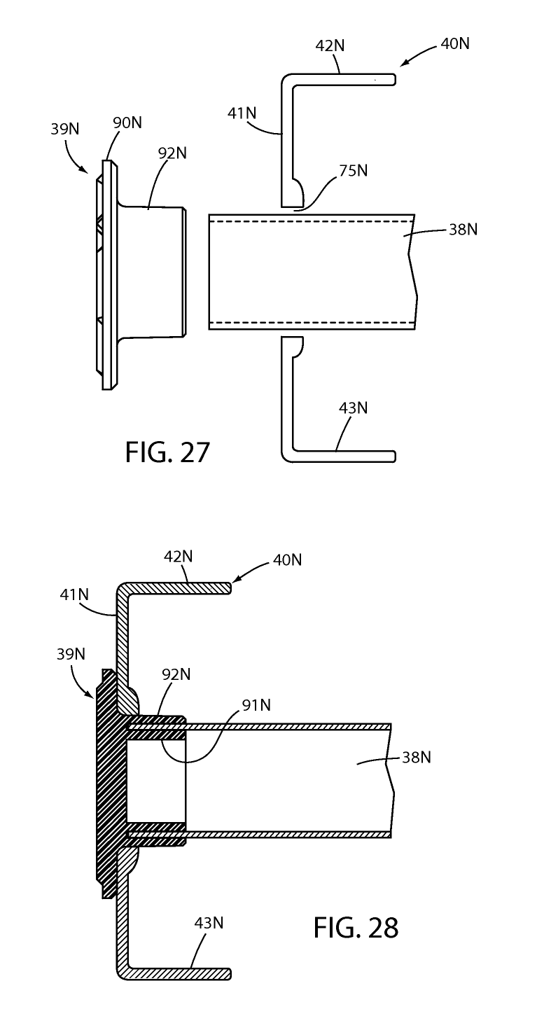

A variety of different rung attachment configurations are contemplated. In a first arrangement (FIGS. 26-26B), a rung-receiving end connector 39N includes a flat outboard wall 90N and concentric rings 91N and 92N forming a pocket there between shaped to receive an end of the rung 38N (FIGS. 27-28). As illustrated, the rung 38N is linear and tubular, and is trapezoidally shaped (though it could be any cross sectional shape desired, such as “D” or “O” shaped). It is also contemplated that the rung 38N can be different materials, such as aluminum, composite, or other. It is also contemplated that the rung may have longitudinal features to facilitate or improve retention and attachment, such as a notch, annular channel or swaged ring.

In FIGS. 27-28, the end of a rung 38N is positioned in an opening 75N in a side rail 40N, and the end connector 39N is forcibly moved onto the end of the rung 38N and into the opening 75N from the outer side of the side rail 40N to form a friction fit. The concentric rings 91N and 92N extend through the center leg 41N of the side rail 40N, and frictionally engage the end of the rung 38N. It is contemplated that the connectors 39N frictionally engage. However, the connector 39N can include a mechanical feature that assists in securely holding the rung 38N on the side rails 40N, such as a resilient tine-supported hook or bump. Also, the connector 39N can be made of a material similar to the side rail 40N, such that it can be integrally bonded to it or, such as by melt-bonding or sonic bonding. Alternatively, the connector 39N can be heated prior to assembly, thus causing the connector 39N when cooled to circumferentially collapse/shrink and bond to the rung 38N (and potentially also bond to the side rail 40N). Also, any of the noted bonding techniques can be used, including rf or sonic or friction welding or solvent bonding. Also, the connector 39N can be a combination of friction fit and/or bonding and/or a lateral hook protrusion. Where the rung 38N has a notch or channel or swaged raised ridge, the connector 39N can positively mechanically lockingly engage the rung when assembled.

It is contemplated that the flat wall 90N of the illustrated connector 39N will engage an outer surface of the side rail's center leg 41N. However, it is also within a scope of the present invention, for the connector 39N to have its flat wall 90N bonded to an inside (inboard) surface of the center leg 41N of the side rail 40N. Alternatively, a raised ring of thermoplastic material can be formed on the inside surface of the center leg 41N around each location where a rung is attached. This allows a rung 38N to be supported with mechanical vertical support (i.e. the raised ring), yet the side rail 40N is not penetrated and the rung 38N does not need to penetrate and extend through the side rail 40N.

FIG. 28A discloses a rung attachment and end connector similar to FIGS. 27-28, but in FIG. 28A, the rung 38P rests directly on the marginal material of the side rail 40P forming the opening 75P. The end connector 39P includes an outer planar wall 110P and an internal plug 111P that fits into the end of the rung 38P. A separate internal sleeve 112P is used to support the rung 38P on an inside of the side rail 40P. It is contemplated that the sleeve 112P will be made of a same material as the side rail 40P, such that the sleeve 112P (and the end connector 39P) can be bonded directly to form a unitary structure (without the need for a separate adhesive).

FIGS. 29-30 illustrate a modified rung attachment where the rung 38Q is aluminum and swaged to form two adjacent raised rings 115Q. The rung 38Q is slid into the opening 75Q in the side rail 40Q, with one swaged raised ring 115Q being on each side of the transverse leg 41Q of the side rail 40Q. A sleeve 116Q is slid onto the end of the rung 38Q over the swaged raised rings 115Q. This can be accomplished by a number of different ways, such as heating the sleeve 116Q (to soften the material), or by providing clearance in the sleeve 116Q (and later heating the sleeve 116Q to shrink it onto the rings 115Q), or by providing a resilient material with memory that will flex sufficiently to slide over the rings 115Q and then later recover and engage them. An end connector 39Q is snapped onto an outer end of the rung 38Q, with the end connector 39Q frictionally engaging an inside of the rung 38Q. The connector 39Q and sleeve 116Q can be melted or otherwise heated or bonded together to form a solid single unitary connector 39Q holding the rung 38Q on the side rail 40Q, with the swaged rings 115Q adding considerable strength to holding the rungs 38Q on the side rail(s) 40Q.

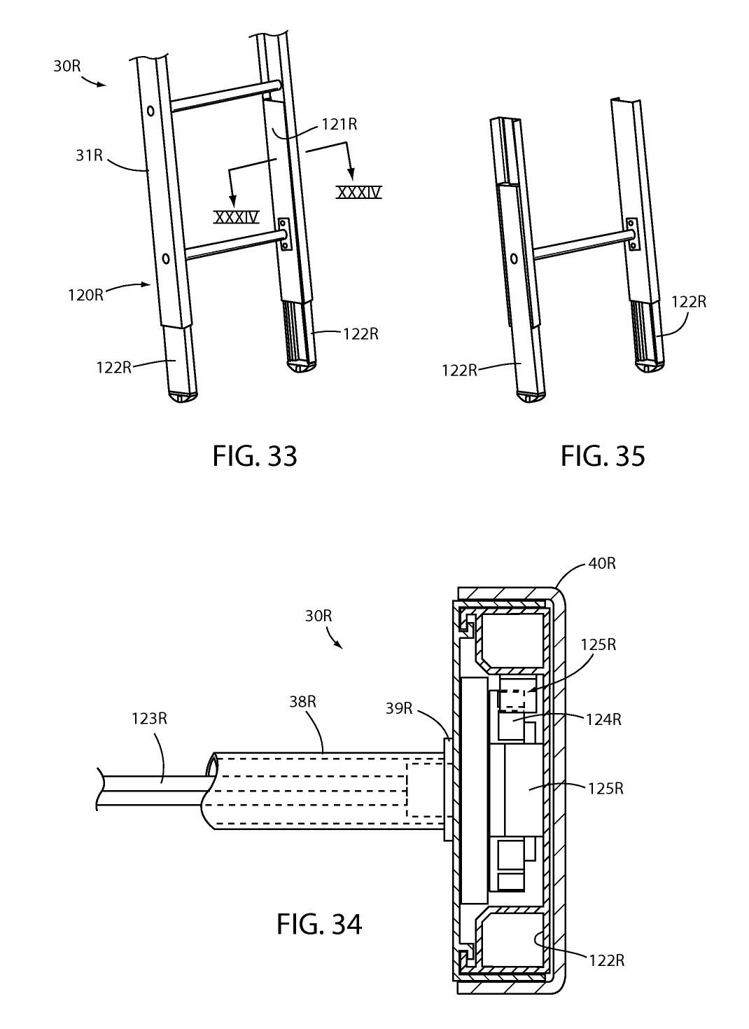

FIGS. 31-33 are perspective views showing a ladder apparatus 30R with leveler 120 attached to its side rails 40R. The leveler 120R includes extendable legs 121R that when at rest are equally extended (FIG. 31), but that adjust to uneven ground when lowered (FIG. 32) and then lock in position for standing on the ladder 30R. FIG. 33 shows a close up of the leveler 120R, showing the leveler 120R being attached to an inside of the associated side rails 40R. The illustrated leveler 120R includes an anchor bracket 121R fixedly attached to a side rail 40R, and an extendable leveling leg 122R that slidably engages the anchor bracket 121R and side rail 40R. A leveling mechanism 123R is provided that extends the leveler leg 122R on one side while retracting the leveler leg 122R on the other side. This is done using a transverse rod 123R with pinions 124R on each end that engage an associated rack 125R attached to the leveler leg 122R and anchor bracket 121R. A locking mechanism 125R locks the leveler legs 122R in a selected adjusted position when pressure is put on both leveler legs 122R.

FIG. 36 shows a cross section of side rails 40S on a base ladder 31S and fly extension ladder 32S, and illustrates inter-engaging flanges 70S on the side rail 40 of the base ladder 31S and the side rail 40S of a fly extension ladder 32S. It is noted that a variety of different inter-engaging flanges can be used. The present illustration is solely to show that a variety of flanges 70 (and 71) can be used to interlockingly attach the two side rails while still permitting telescoping extension.

Notably, the rungs 38S prevent the flanges 71S from disengaging, yet permit telescoping extension. FIGS. 37 and 38 show feet 130T that can be attached to the side rail 40T of the present innovative ladder 30T. FIG. 37 is a fixed stationary foot 130T; including a ground-engaging member 131T configured for non-slip engagement with the ground, and including parallel attachment straps 132T with holes 133T for attachment to opposing legs of a side rail 40T. FIG. 38 illustrates a foot 130U that can be pivoted to accommodate non-level terrain. Specifically, the foot 130U includes a ground engaging sole 131U, and a trunnion bracket 135U that is pivoted to the sole 131U for rotation about a first axis 136U and that includes upright straps 132U with apertures 133U for attachment to a side rail using threaded fasteners. (See holes in FIG. 25).

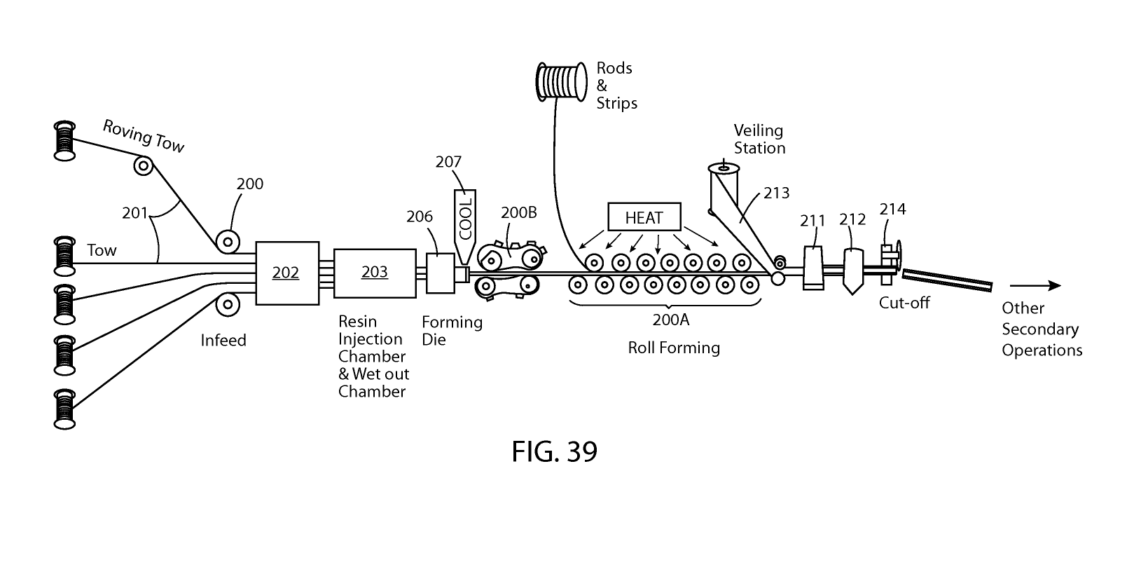

The modified pultrusion process shown in FIG. 39 comprises steps of: providing a pultrusion apparatus including in-feed rollers 200 and pull rollers 200B for feeding long continuous reinforcement fibers 201, a pre-heat surface treatment chamber 202, a wet-out chamber 203, a supply of thermoplastic resin operably connected to an injection machine and an injection nozzle for injecting the heated melted thermoplastic resin into the wet-out chamber 203, a forming die 206, a quench basin or cooling station/bed 207, and a puller (200B) for pulling the fibers through the wet-out chamber 203 and the forming die 206. Secondary stations include roll form rollers 200A that reshapes the cross-sectional profile, rolls and smooths edges, a drilling station 211 that removes material, punch/pressure plunger station 212 that reforms material by moving thermoplastic resin material (i.e. “shifting the material” from one location to another location on the beam), and a veiling station 213 that adds material (such as adding low-friction material extending partially or fully around the beam) downstream of the forming die, all of which use heat (either added heat or using existing internal heat in the partially-cooled plastic) and pressure. Adhesives and adhesive enhancers can be used if desired/needed in the veil station 213.

Notably, for example, the punch/pressure plunger station 212 can include a punch with a tapered tip that moves against an opposing die with mating aperture, which tip separates the fibers (rather than fracturing or cutting the fibers) when entering the C-shaped beam's transverse center wall or legs. Alternatively, the punch can include a squared tip that punches out a section of material as it initially presses against the beam's transverse center wall or leg walls. Alternatively, the punch can include a combination that both punches a small section out of the beam and also has a tapered collar that spreads adjacent fibers in the beam's walls while it simultaneously moves material to an adjacent area. Also, the veiling station 213 can include a coating applied to the outer surface of the pultruded beam shape. The veiling station 213 can include roll forming rolls that both press sheet material against the beam with sufficient force to cause bonding (potentially assisted by adhesive or adhesive enhancers). The roll forming rolls in a roll forming station also can reshape walls or edges or surfaces of the beam, adding a lip to an end of a flange or wall, and/or eliminating roughness at corners and wall ends and in other locations, as discussed below. A cutoff station 214 cuts off the continuous pultruded beam into beam segments of desired length.

The method includes: forming a continuous pultruded product (such as a ladder side rail) by injecting thermoplastic resin into the wet-out chamber while pulling the long continuous reinforcement fibers through the wet-out chamber and forming die; and cutting the continuous pultruded product to a predetermined length to form a beam. The process wets continuous (pultruded) fibers with thermoplastic resin material, using in-line and downstream secondary processing of the pultruded beam, primarily without (or with minimal) material waste. Briefly, FIG. 39 discloses a modified pultrusion process for injecting thermoplastic resin into a wet-out die, and pulling fibers through the wet-out die, and includes in-line downstream secondary processes, including a material-adding station and a hole-forming station. The material-adding station, for example, can add/adhere an outer skin or “veil” or reinforcing/strengthening strips to the pultruded beam for providing stressed-skin beam strength). The hole-forming station can be a drill or punch (which removes material), or a tapered punch or press (which moves material to reform the material to form a feature on the beam).

It is noted that the thermoplastic resin forms a skin on the illustrated cross sections, and further that internally; the fibers and internal reinforcing members can be uniformly distributed or strategically non-uniformly distributed in higher and lower density regions in the cross sections. For example, reinforcement rods can be located at strategic locations, such as at corners or high stress locations in the cross sections. Also, it may be desirable to include lower (or higher) concentrations of fibers in areas where post-pultrusion secondary processes move thermoplastic material.

A goal of the present initial project was to create a C-shaped profile for use as a ladder side rail, which provided necessary strength and light weight. However, our testing and development experience suggests that the present pultrusion of thermoplastic material is much broader than just for ladder side rails. The innovative improvements to the process are considered to provide surprising and unexpected results given the unexpected significant weight savings, improved strength-to-weight properties, and surprising ability to include integrated in-line secondary processes downstream of the pultrusion wet-out die before cutoff. In particular, the secondary processes can take advantage of the ability to reform (i.e. “shift”) the thermoplastic material using heat and pressure, including the ability to move fibers laterally to positions extending around a hole (instead of breaking or cutting them when forming the hole).

It is contemplated that the present innovations can be extended to materials other than thermoplastic urethane resin (TPU). The TPU resin offers strength and light weight, yet allows for high fiber content and fiber. It allows use of fibers, fiber bundles, fiber mats and strips and tapes (with untwisted or twisted or woven fibers, and with unfolded or folded or rolled shapes), and/or rods, each of which can be carbon fiber, glass fiber, metal fiber/rod, or other material. It is contemplated that other thermoplastic resins can be used, such as Nylon 66 resin with a Kevlar reinforcement. Other reinforcements can include stainless steel, Kevlar with varying amounts of carbon fiber or nano-clays (especially where conductivity is an issue). Lengths of reinforcement fibers of varying thickness and width and location can be used.

The present thermoplastic pultruded beams have the possibility of providing a final profile and shape with integral site-specific features in a single pultruding process (using in-line secondary processing stations, and taking advantage of the internal heat of the semi-rigid thermoplastic material within the just-formed pultruded beam prior to being fully cooled). Alternatively, the secondary processes can be done off-line, using localized heat and pressure calculated to reform (or remove) material at localized sites along the beam while leaving other “remote” areas of the beam unaffected. It is contemplated that the “veiling station” (213) can be used to apply a sheet to a surface of the pultruded beam, utilizing rollers and rollforming to ensure sufficient pressure and bonding of the veil to the beam. This is possible since the process doesn't need a lot of pressure at that point in the process, since the reinforcement fibers are already wet-out in the final profile shape of the beam, and all that is needed is to let the veil bond (called “consolidate”) onto the exterior of the final profile shape of the beam. It is contemplated that rollforming is potentially useable to finish-form and finally-shape the beam to achieve a specific dimensionally-accurate C-shape profile, and/or to roll edges of the C-shaped profile of the beam, since the distinct layers of the fiber reinforcement could otherwise leave a rough/raw edge on the beam leading to crack-initiation sites and other roughness issues. The idea of using rods on corners to cap and to ensure smooth edges and corner transitions during veiling process is believed to be a very promising innovation improving beam strength and properties. A preferred beam can use a mixture of fiber skins and rods in the final composition.

It is contemplated that the present fiber reinforced thermoplastic pultruded beam can use heated air or UV to heat “backwards” where consolidation will occur (i.e. downstream of the wet-out die in a secondary station), so that most of the heat is right before consolidation rollers or dies (which press the sheet or strip against the beam), with some heat pre-heating the reinforcement strips or rods coming in. Rods more than strips would allow the heat to penetrate. Using strips and rods in a thermoplastic pultrusion or roll forming process is believed to be novel and unobvious.

It is believed that the illustrated hybrid process in FIG. 39 which combines roll forming with pultrusion is very innovative and offers a totally new process with new capabilities. It overcomes some consistent obstacles of a thermoplastic pultrusion, namely friction and surface finish. The formed beam already has wet-out of the reinforcement fibers in the beam (downstream of the wet-out die), thus allowing friction to be lessened, since there is no need for added pressure to assist wet-out at this point in the pultrusion process.

In FIG. 39, reinforcement fibers are fed by spools and rollers and into a wet-out die and forming die to shape the beam profile. The wet-out die and forming die consolidate the thermoplastic resin with embedded reinforcement fibers, into a desired structural beam shape. Once the desired structural beam shape is formed, strips and rods are strategically added, then it proceeds into a roller forming system that provides final reshaping cross-sectional profile, rolls and smoothing of edges after which it proceeds in a manner allowing the veil station 213 add a veil or skin onto the final C-shape of the illustrated ladder side rail. Heat (UV, Air, or other heat source) is applied along with roller pressure and guides will form the final C-shape. When the thermoplastic resin is exposed to heat, it will be drawn to the surface of the beam, while keeping some resin in contact with wet-out embedded fibers. Once in a final profile form (using a straight wall die and/or the roller forming rolls) and the beam is cooled sufficiently, the process moves the beam downstream for drilling, punching, threading, insertion of rungs (when manufacturing a ladder), and cutoff operations. Heated operations include the addition of fibers to reinforce certain areas of a ladder side rail or rungs or rung mounting locations, including over-molding of parts, straightening, or the addition of skins can be done in-line and before veiling station and final cooling, or can be done in a separate secondary operation.

An important innovation is the addition of the veiling station, where a skin is attached to the beam, for improved finish (i.e. less roughness and increased beam strength (based on stressed-skin beam strength properties).

Roll forming processes are known and do not need to be described in detail in the present application for an understanding by persons skilled in the art of manufacturing beams. It is noted that we did not find commercial processes combining pultrusion with roll forming, nor combining thermoplastic veiled components with roll forming. It is contemplated that a scope of the present invention includes providing veiled beams (i.e beams with adhered/bonded sheets extending partially or fully around a beam's perimeter) made of thermoset materials, as well as thermoplastic materials. For example, this innovative process can be used on corrugated fiberglass roofing sheets (which are often used in pole building and garages).

It is believed to be particularly innovative to use roll forming as a secondary operation with composite rods and strips, where feeder rollers and guides are used to pinch and cause fixation of veil while re-shaping a beam.

Using heat with thermoplastic resin is a great facilitator, since it can be used and applied at different stages of the process, and applied only at predetermined localized locations.

Thus, it is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A method comprising:
pultruding a first beam shape by pulling long reinforcement fibers through resin in a pultrusion wet-out die; and
using secondary stations downstream and in-line with the wet-out die before cutoff to form a final beam shape different than the first beam shape, the secondary stations including at least one of: a material-adding station, a veiling station, a punch station, a material removing station, a drill station, and/or a roll form station.

2. The method defined in claim 1, wherein the resin is a thermoplastic material.

3. The method defined in claim 2, wherein the final beam defines a ladder side rail.

4. The method defined in claim 3, including assembling rungs to two of the ladder side rails to form an assembled ladder.

5. The method defined in claim 2, wherein the resin includes a concentration of nano-particle reinforcer material.

6. The method defined in claim 5, wherein the concentration of nano-particle reinforce material is less than about 2%.

7. The method defined in claim 1, wherein the secondary station includes the material-adding station, the material-adding station including coating a surface of the first beam shape with a low friction material and thereafter including another one of the secondary stations that engages the coated surface with a die as part of an in-line reforming operation on the first beam shape to produce the final beam shape.

8. The method defined in claim 1, wherein the secondary station includes the veiling station, the veiling station including adhering and bonding an elongated sheet to an outer surface of the first beam shape as part of forming the final beam shape.

9. The method defined in claim 8, wherein the elongated sheet completely covers a perimeter of a cross section of the final beam shape.

10. The method defined in claim 1, wherein the secondary station includes the punch station, the punch station including a punch that periodically moves against an opposing die to move material from a first local area to selected adjacent area of the first beam shape as part of forming the final beam shape.

11. The method defined in claim 1, wherein the secondary station includes one of the drill station and the punch station, the one station forming a hole through a wall of the first beam shape as part of forming the final beam shape.

12. The method defined in claim 1, wherein the secondary station includes the roll form station, the roll form station moving material to reshape the profile of the first beam shape into the profile of the final beam shape.

13. A beam product comprising:
a pultruded beam having a length and including a plurality of longitudinally-extending continuous fibers extending the length and that are fully wetted by thermoplastic material, the beam defining a constant continuous cross section along the length, but including discontinuous features spaced along the length that interrupt the constant continuous cross section.

14. The beam product of claim 13, wherein the features include 3-dimensional features extending outside the defined constant continuous cross section that are formed by moving some of the thermoplastic material from a first location on the beam to the 3-dimensional features using heat and pressure.

15. A beam product of claim 13, wherein the features include openings extending through the cross section, with at least some of the continuous fibers extending unbroken around the openings.

16. A ladder comprising side rails and rungs extending between the side rails, each of the side rails incorporating one of the beam products defined in claim 13.

17. A beam product comprising:
a pultruded beam including longitudinally-extending continuous fibers fully wetted by thermoplastic material to form a continuous cross section, the beam having first and second longitudinally-extending parallel leg sections and a transverse leg section connecting the parallel leg sections, and having a flat elongated strip of high strength material bonded to an exterior surface of each of the parallel leg sections, the strips providing a stressed skin strength to the beam so as to significantly increase a load strength of the beam.

18. The beam product of claim 17, wherein the parallel leg sections include tips and also include corners with the transverse leg section, at least one of the tips and corners having reinforcing rods extending a length of the beam.

19. A process comprising steps of:
providing a pultrusion apparatus including in-feed rollers for feeding long continuous reinforcement fibers, a pre-heat surface treatment chamber, a wet-out chamber, an injection nozzle for injecting thermoplastic resin into the fibers in the wet-out chamber, a forming die, a cooling station, and a puller for pulling the fibers through the wet-out chamber and the forming die;
forming a continuous pultruded product by injecting thermoplastic resin into the wet-out chamber while pulling the long continuous reinforcement fibers and thermoplastic resin through the wet-out chamber and through the forming die; and
cutting the continuous pultruded product to a predetermined length to form a beam.

20. The process defined in claim 19, including a step of vibrating one or both of the forming die and the wet-out chamber.

21. The process defined in claim 19, including a step of providing the thermoplastic resin, the resin including a concentration of nano-particle reinforcer material.

22. The process defined in claim 21, wherein the concentration of reinforce material is less than 2%.

23. The process defined in claim 19, wherein an initially-pultruded product with constant cross section exits the forming die, and including a step of reforming some of the thermoplastic resin in the initially-pultruded product using heat and pressure to form desired integral features on beam, with the integral features being formed by material moved to or from selected areas of the initially-pultruded product.

24. The process defined in claim 19, wherein an initially-pultruded product with constant cross section exits the forming die, and including a secondary processing steps in-line with and downstream of the forming die, the secondary processing steps being selected from a group consisting: removing some of the thermoplastic resin, reforming some of the thermoplastic resin, adhering a structural strip or rod onto the thermoplastic resin.
